(19) United States
(12) Patent Application Publication
(10) Pub. No.: US 2024/0414500 A1
(43) Pub. Date: Dec. 12, 2024

(54) DOWNLINK-BASED AI/ML POSITIONING FUNCTIONALITY AND MODEL IDENTIFICATION

(71) Applicant: QUALCOMM Incorporated, San Diego, CA (US)

(72) Inventors: Mohammed Ali Mohammed HIRZALLAH, San Diego, CA (US); Taesang YOO, San Diego, CA (US); Rajat PRAKASH, San Diego, CA (US)

(21) Appl. No.: 18/331,014

(22) Filed: Jun. 7, 2023

(51) Int. Cl. H04W 4/029; G06N 20/00

(52) U.S. Cl. CPC H04W 4/029; G06N 20/00

(57) ABSTRACT

Aspects presented herein may enable a UE and a network entity to have a common understanding for AI/ML models used in association with AI/ML positioning, thereby improving the performance and efficiency of AI/ML positioning. In one aspect, a UE transmits, to a network entity, a list of UE-supported AI/ML positioning functionalities. The UE receives, from the network entity, an indication of a set of network-supported AI/ML positioning functionalities that are supported by the network entity. The UE transmits, to the network entity, a PRS-based measurement or an estimated location of the UE that is based on using at least one AI/ML model associated with at least one UE-supported AI/ML positioning functionality in the list of UE-supported AI/ML positioning functionalities or at least one network-supported AI/ML positioning functionality in the set of network-supported AI/ML positioning functionalities.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a network entity, a list of UE-supported features or feature groups related to a first set of artificial intelligence (AI)/machine learning (ML) (AI/ML) positioning functionalities that are support by the UE. The apparatus receives, from the network entity, an indication of a set of network-supported features or feature groups related to a second set of AI/ML positioning functionalities that are supported by the network entity. The apparatus transmits, to the network entity, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

In an aspect of the disclosure, a method, a computer-readable medium, and an apparatus are provided. The apparatus receives, from a user equipment (UE), a list of UE-supported features or feature groups related to a first set of AI/ML positioning functionalities that are support by the UE. The apparatus transmits, for the UE, an indication of a set of network-supported features or feature groups related to a second set of AI/ML positioning functionalities that are supported by the network entity. The apparatus receives, from the UE, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of UE-based positioning with UE-side AI/ML model, direct artificial intelligence (AI)/machine learning (ML) (AI/ML) or AI/ML assisted positioning in accordance with various aspects of the present disclosure.

FIG. 6A is a diagram illustrating an example of UE-assisted/location management function (LMF)-based positioning with UE-side AI/ML model, AI/ML assisted positioning in accordance with various aspects of the present disclosure.

FIG. 6B is a diagram illustrating an example of UE-assisted/LMF-based positioning with LMF-side model, direct AI/ML positioning in accordance with various aspects of the present disclosure.

FIG. 7A is a diagram illustrating an example of network (e.g., a next generation (NG) radio access network (RAN) (NG-RAN)) node assisted positioning with gNB-side model, AI/ML assisted positioning in accordance with various aspects of the present disclosure.

FIG. 7B is a diagram illustrating an example of network (e.g., NG-RAN) node assisted positioning with LMF-side model, direct AI/ML positioning in accordance with various aspects of the present disclosure.

FIG. 8A is a diagram illustrating an example of direct AI/ML positioning in accordance with various aspects of the present disclosure.

FIG. 8B is a diagram illustrating an example of AI/ML assisted positioning in accordance with various aspects of the present disclosure.

FIG. 9 is a diagram illustrating an example hierarchy of an AI/ML positioning functionality and identification in accordance with various aspects of the present disclosure.

FIG. 10 is a communication flow illustrating an example of a target and a location server exchanging supported AI/ML positioning model functionality ID(s), model ID(s), and realization/model ID(s) in accordance with various aspects of the present disclosure.

FIG. 11 is a diagram illustrating an example of DL-based AI/ML positioning functionality IDs that are specified based on deployment cases in accordance with various aspects of the present disclosure.

FIG. 12 is a diagram illustrating an example of DL-based AI/ML positioning functionality IDs that are specified based on deployment cases along with AI/ML model source indication in accordance with various aspects of the present disclosure.

FIG. 13 is a diagram illustrating an example of DL-based AI/ML positioning functionality IDs that are specified based on deployment cases along with model input description in accordance with various aspects of the present disclosure.

FIG. 14 is a diagram illustrating an example of DL-based AI/ML positioning functionality IDs that are specified based on deployment cases along with model output description in accordance with various aspects of the present disclosure.

FIG. 15 is a diagram illustrating an example of DL-based AI/ML positioning functionality IDs that are specified based on deployment cases, a model source indication, a model input description, a model output description, a model complexity, a validity condition, operational specifications, or a combination thereof in accordance with various aspects of the present disclosure.

FIG. 16 is a flowchart of a method of wireless communication.

FIG. 17 is a flowchart of a method of wireless communication.

FIG. 18 is a diagram illustrating an example of a hardware implementation for an example apparatus and/or network entity.

FIG. 19 is a flowchart of a method of wireless communication.

FIG. 20 is a flowchart of a method of wireless communication.

FIG. 21 is a diagram illustrating an example of a hardware implementation for an example network entity.

### DETAILED DESCRIPTION

Aspects presented herein may improve the performance and efficiency of artificial intelligence (AI)/machine learning (ML) (AI/ML) positioning by providing a signaling framework that enables a location server (e.g., an LMF) and a target (e.g., a UE) to recognize AI/ML model identification/identifier (ID) (which may also be referred to as AI/ML positioning ID in some examples) and/or AI/ML functionality (which may also be referred to as AI/ML functionality ID in some examples) for DL-based AI/ML positioning. For example, in one aspect of the present disclosure, an AI/ML positioning model may be assigned with a model ID and/or a functionality based on the representative use case, e.g., a first functionality (Functionality1) may be associated with direct AI/ML positioning, whereas a second functionality (Functionality2) may be associated with AI/ML assisted positioning, etc. In some implementations, a functionality may further be specified based on where the AI/ML model is implemented/running. In some implementations, the functionality may also be specified based on AI/ML model input and/or output (e.g., direct AI/ML positioning with channel impulse response (CIR) model input, direct AI/ML positioning with reference signal received power (RSRP) model input, AI/ML assisted positioning with line-of-sight (LOS) identification output, AI/ML assisted positioning with time of arrival (ToA) estimation output, etc.).

In addition, for a given functionality, one or more AI/ML models may be identified and assigned with unique ID(s). Thus, one functionality may have multiple AI/ML models identified, where these AI/ML models may be configured to have different complexities, operational specifications, validity conditions, and/or performance guarantees, etc. An identified AI/ML model for a given AI/ML positioning functionality may also be assigned with several model realization IDs, where a realization (or a realization ID) of a given AI/ML model may serve as a set of parameter weights for the AI/ML model (e.g., to account for generalization to unseen/partially seen changes in a wireless environment). As such, aspects presented herein may improve performance and efficiency of AI/ML positioning (e.g., training and inferencing) by enabling a location server and a UE to have a common/better understanding for AI/ML model(s) used for the AI/ML positioning.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

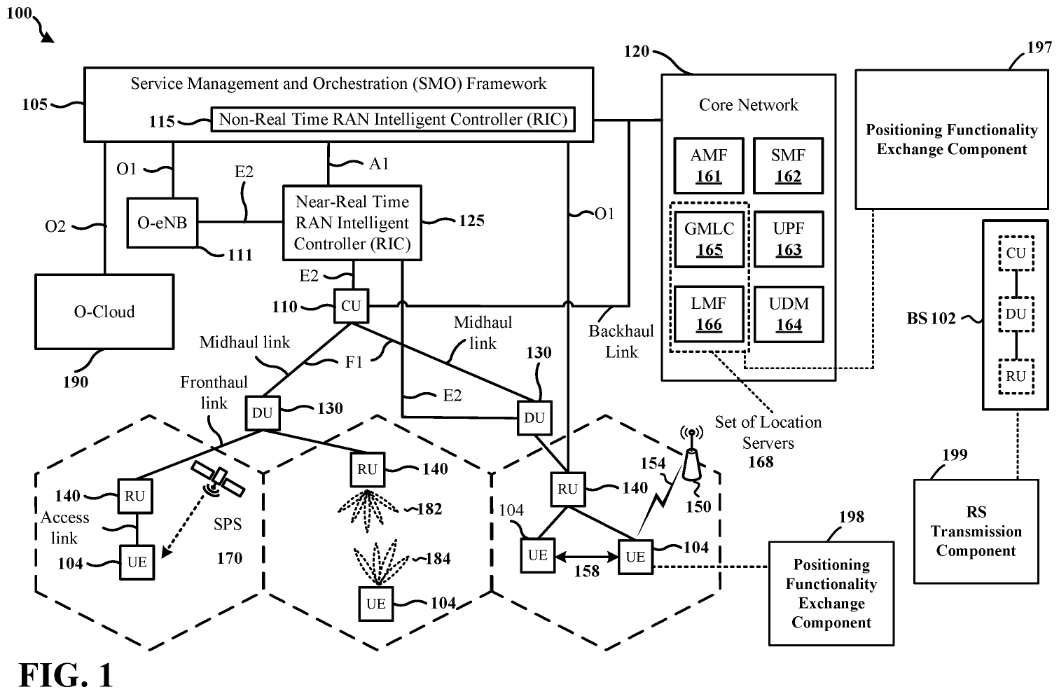

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz—7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a positioning functionality exchange component 198 that may be configured to transmit, to a network entity, a list of UE-supported features or feature groups related to a first set of AI/ML positioning functionalities that are support by the UE; receive, from the network entity, an indication of a set of network-supported features or feature groups related to a second set of AI/ML positioning functionalities that are supported by the network entity; and transmit, to the network entity, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group related in the set of network-supported features or feature groups related to the second set of AI/ML positioning functionalities.

In certain aspects, the one or more location servers 168 may include a positioning functionality exchange component 197 that may be configured to receive, from a UE, a list of UE-supported features or feature groups related to a first set of AI/ML positioning functionalities that are support by the UE; transmit, for the UE, an indication of a set of network-supported features or feature groups related to a second set of AI/ML positioning functionalities that are supported by the network entity; and receive, from the UE, a PRS-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

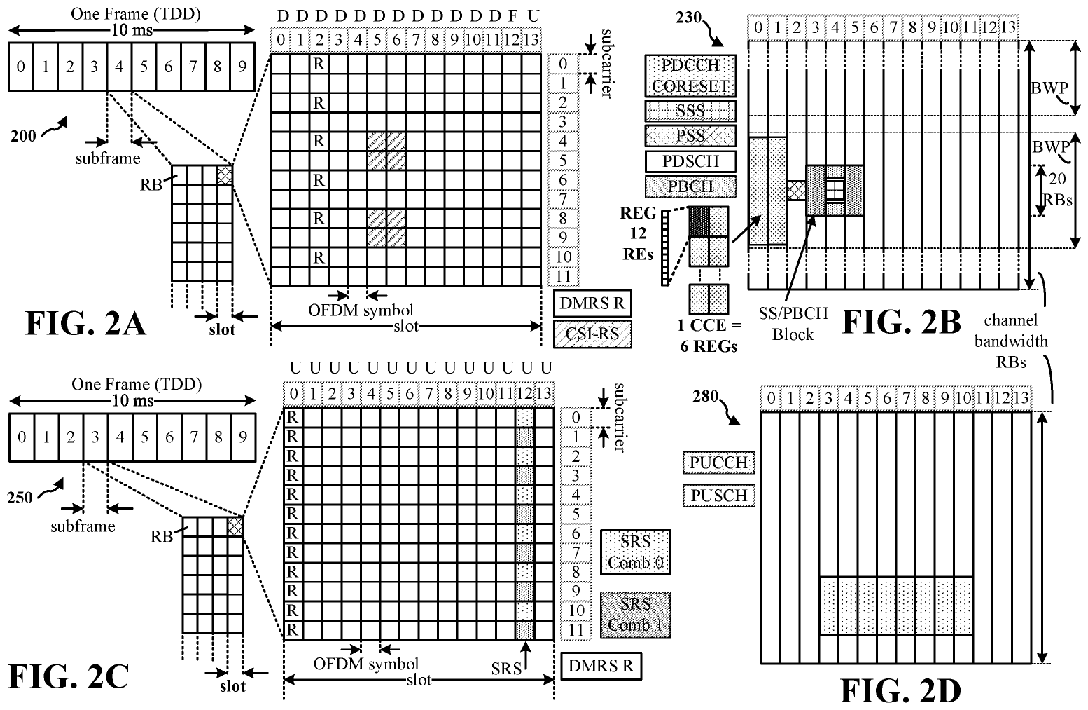

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

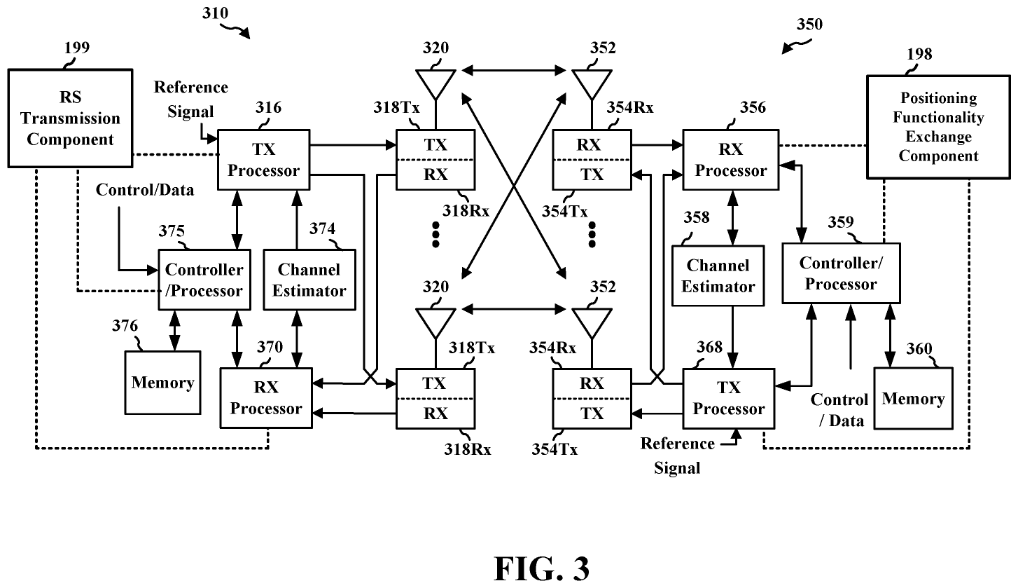

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the positioning functionality exchange component 198 of FIG. 1.

At least one of the TX processor 316, the RX processor 370, and the controller/processor 375 may be configured to perform aspects in connection with the RS transmission component 199 of FIG. 1.

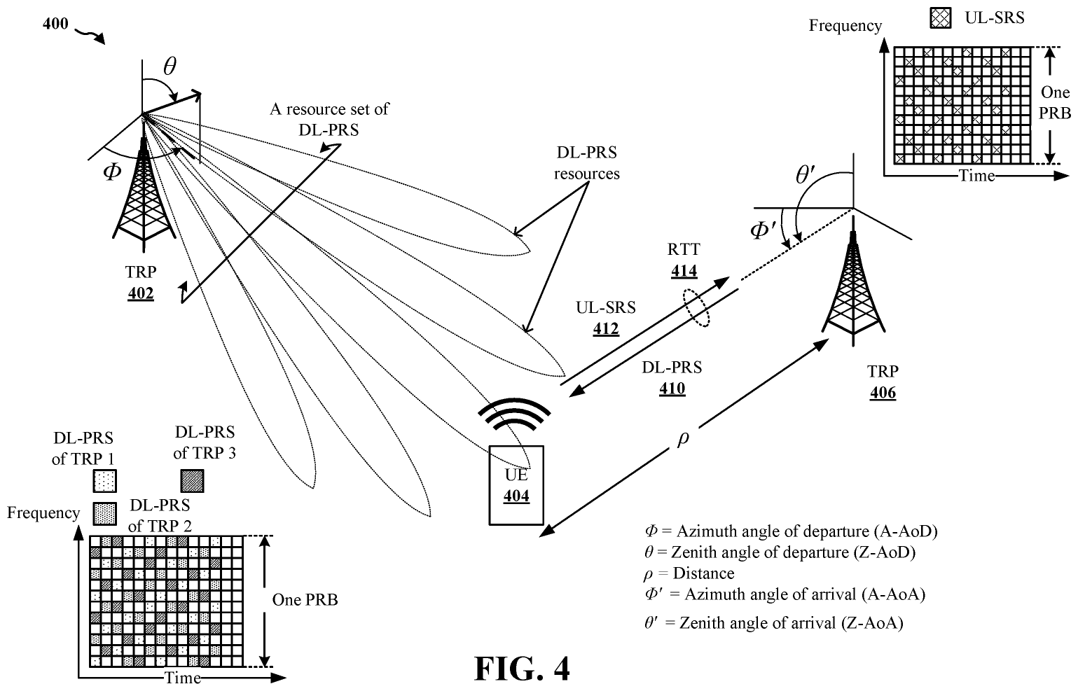

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS}_Rx. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In some implementations, at least one artificial intelligence (AI)/machine learning (ML)(AI/ML) model may be configured/implemented at a UE or at a network entity/node (e.g., a base station, a location server, a location management function (LMF), etc.) for assisting the UE and/or the network entity/node with the positioning of the UE. For example, an AI/ML model may be trained to determine the position of a UE based on DL-AoD, DL-TDOA, channel impulse response (CIR), radio frequency (RF) fingerprinting, etc. In most scenarios, using an AI/ML model may significantly improve UE positioning latency, accuracy/reliability, and/or efficiency.

For purposes of the present disclosure, “model identification/ID” and/or “AI/ML model identification/ID” may refer to a process/method of identifying an AI/ML model for the common understanding between a network (NW) and a UE. The process/method of the model identification (or model ID) may or may not be applicable depending on implementations and scenarios. In some examples, information regarding the AI/ML model may be shared during the model identification. On the other hand, “functionality identification/ID,” “AI/ML functionality identification/ID,” and/or “model functionality identification/ID” may refer to a process/method of identifying an AI/ML functionality for the common understanding between a network and a UE. Similarly, information regarding the AI/ML functionality may be shared during the functionality identification.

In some scenarios, an AI/ML model that is implemented at a UE side may be referred to as a “UE-side model” and/or “UE-side AI/ML model.” On the other hand, an AI/ML model that is implemented at a network side may be referred to as a “network-side model,” “network-side AI/ML model,” and/or (network name)-side AI/ML model (e.g., base station-side AI/ML model, LMF-side AI/ML model, etc.).

In addition, positioning that is associated with a UE or a network entity/node using an AI/ML model to determine the position of the UE may be referred to as “direct AI/ML positioning,” whereas positioning that is associated with a UE or a network entity/node performing positioning related measurements using an AI/ML model (and transmitting the positioning related measurements to another entity) to determine the position of the UE may be referred to as “AI/ML assisted positioning” and/or “assisted AI/ML positioning.” Also, UE-based positioning (e.g., UE determines its own position) using at least one UE-side AI/ML model may be referred to as “direct UE AI/ML positioning” and/or “UE direct AI/ML positioning,” whereas UE-assisted positioning (e.g., a UE provides positioning measurements and a network entity, such as an LMF, determines the position for the UE based on the positioning measurements provided by the UE) using at least one UE-side AI/ML model may be referred to as “UE AI/ML assisted positioning,” “UE assisted AI/ML positioning” “AI/ML assisted UE positioning,” and/or “AI/ML UE assisted positioning,” etc. Similarly, network-based positioning (e.g., a network entity, such as an LMF, determines the position for the UE) using at least one network/LMF-side AI/ML model may be referred to as “direct network/LMF AI/ML positioning” and/or “network/LMF direct AI/ML positioning.”

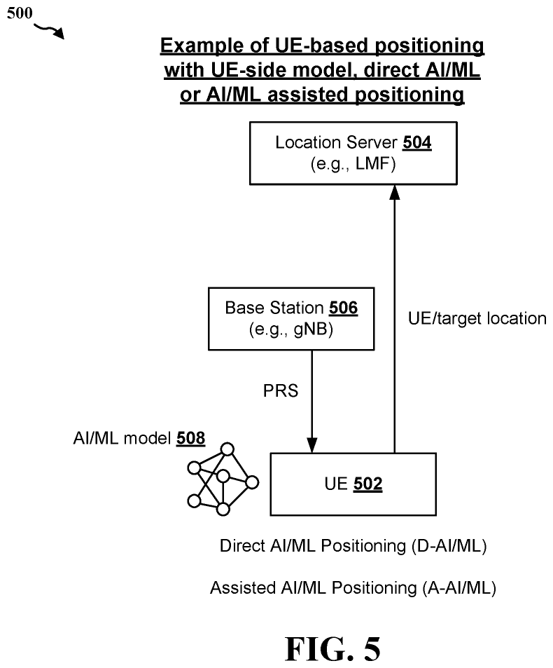

FIG. 5 is a diagram 500 illustrating an example of UE-based positioning with UE-side AI/ML model, direct AI/ML or AI/ML assisted positioning in accordance with various aspects of the present disclosure. In one implementation, a UE 502 may be associated with at least one AI/ML model 508, and the UE 502 may use the at least one AI/ML model 508 to perform the direct AI/ML positioning and/or the assisted AI/ML positioning based on downlink (DL) reference signals, such as positioning reference signals (PRSs). For example, the UE 502 may receive and measure a set of PRSs transmitted from a base station 506, such as measuring the reference signal received power (RSRP), channel impulse response (CIR), DL-AoD, and/or time of flight (ToF) of the set of PRSs, time of arrival (ToA), reference signal time difference (RSTD), etc., which may be collectively be referred to as “PRS measurement(s)” and/or “PRS-based measurement(s).” In some examples, the UE 502 may use the at least one AI/ML model 508 for measuring the set of PRSs (e.g., for assisted AI/ML positioning). In some examples, based on the PRS measurement(s), the UE 502 may use the at least one AI/ML model 508 for determining its position (e.g., for direct AI/ML positioning). Note in this assisted AI/ML positioning example, the UE 502 may use the at least one AI/ML model 508 for performing PRS measurements, and the UE 502 may determine its position based on the PRS measurements without the assistance of an AI/ML model.

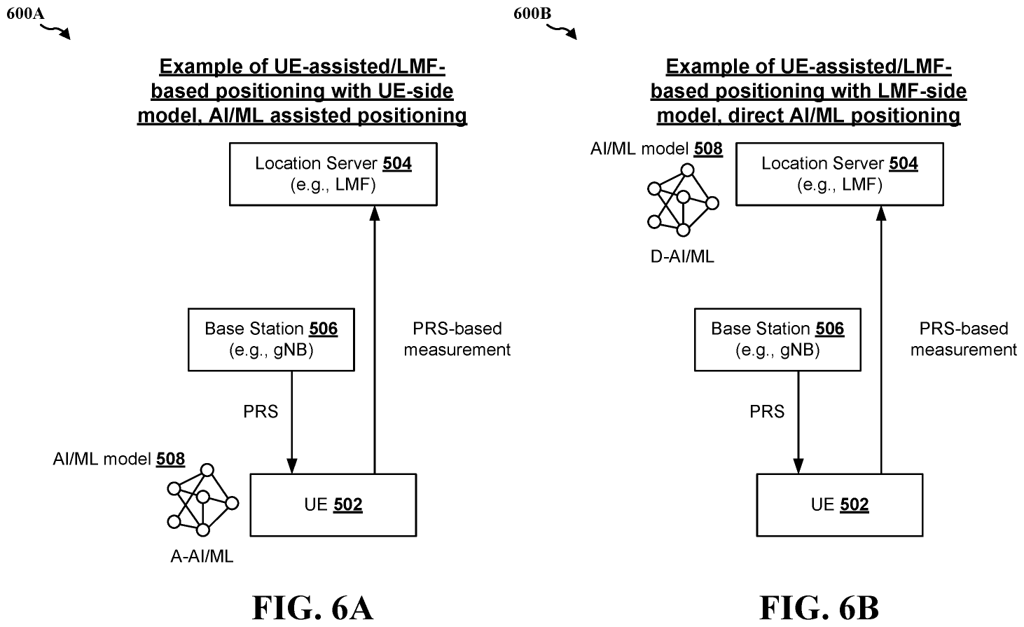

FIG. 6A is a diagram 600A illustrating an example of UE-assisted/LMF-based positioning with UE-side AI/ML model, AI/ML assisted positioning in accordance with various aspects of the present disclosure. In another implementation, a UE 502 may be associated with at least one AI/ML model 508, and the UE 502 may use the at least one AI/ML model 508 to perform or assist measurement(s) of DL reference signals. For example, the UE 502 may receive and measure a set of PRSs transmitted from a base station 506 with the assistance of the at least one AI/ML model 508, which may be referred to as “PRS-based measurement(s)” Then, the UE 502 may transmit the PRS-based measurement(s) to a location server 504, such as an LMF. In response, the location server 504 may determine the position of the UE 502 based on the PRS-based measurement(s) (with or without suing an AI/ML model).

FIG. 6B is a diagram 600B illustrating an example of UE-assisted/LMF-based positioning with LMF-side AI/ML model, direct AI/ML positioning in accordance with various aspects of the present disclosure. In another implementation, a UE 502 may not include a UE-side AI/ML model, and a location server 504 may use at least one AI/ML model 508 to determine the position of the UE 502. For example, the UE 502 may receive and measure a set of PRSs transmitted from a base station 506, and the UE 502 may transmit the positioning reference signal (PRS)-based measurement(s) to the location server 504, such as an LMF. In response, the location server 504 may use the at least one AI/ML model 508 to determine the position of the UE 502 based on the PRS-based measurement(s) from the UE 502.

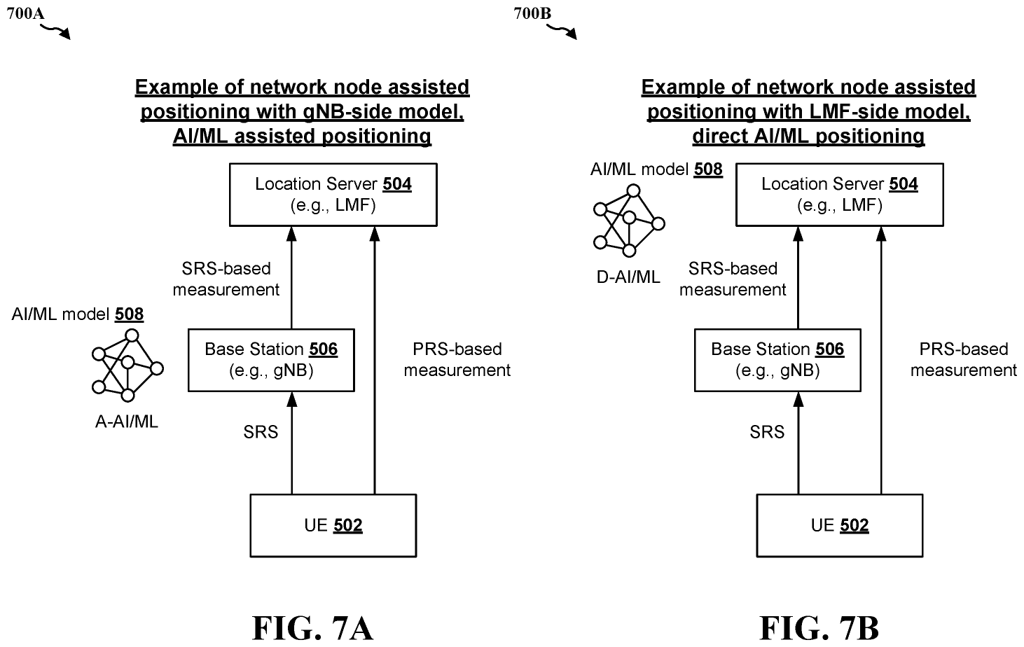

FIG. 7A is a diagram 700A illustrating an example of network (e.g., NG-RAN) node assisted positioning with gNB-side AI/ML model, AI/ML assisted positioning in accordance with various aspects of the present disclosure. In another implementation, a network node, such as a base station 506, may be associated with at least one AI/ML model 508, and the base station 506 may use the at least one AI/ML model 508 to assist measurement(s) of uplink (UL) reference signals, such as sounding reference signals (SRSs). For example, the UE 502 may transmit a set of SRSs to the base station 506, and the base station 506 may receive and measure the set of SRSs (which may be referred to as “SRS-based measurement(s)”) with the assistance of the at least one AI/ML model 508. Then, the base station 506 may transmit the SRS-based measurement(s) to the location server 504, such as an LMF. In response, the location server 504 may determine the position of the UE 502 based on the SRS-based measurement(s) from the base station 506 (with or without suing an AI/ML model).

FIG. 7B is a diagram 700B illustrating an example of network (e.g., NG-RAN) node assisted positioning with LMF-side AI/ML model, direct AI/ML positioning in accordance with various aspects of the present disclosure. In another implementation, a network node, such as a base station 506, may not include an AI/ML model, and a location server 504 may use at least one AI/ML model 508 to determine the position of a UE 502. For example, the UE 502 may transmit a set of SRSs to the base station 506, and the base station 506 may receive and measure the set of SRSs. Then, the base station 506 may transmit the SRS-based measurement(s) to the location server 504, such as an LMF. Based on the SRS-based measurement(s) from the base station 506, the location server 504 may use the at least one AI/ML model 508 to determine the position of the UE 502. For purposes of the present disclosure, positioning described in connection with FIGS. 5, 6A, and 6B may be referred to as AI/ML positioning based on DL reference signals, and positioning described in connection with FIGS. 7A and 7B may be referred to as AI/ML positioning based on UL reference signals.

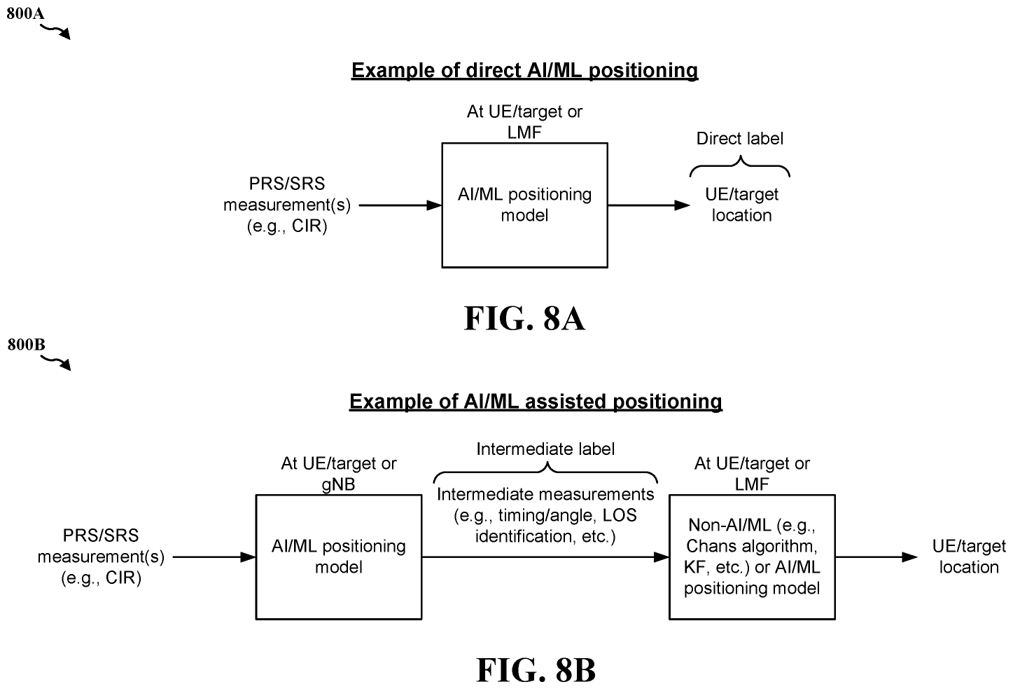

FIG. 8A is a diagram 800A illustrating an example of direct AI/ML positioning in accordance with various aspects of the present disclosure. As described in connection with FIGS. 5, 6B, and 7B, for direct AI/ML positioning, a network entity (e.g., a UE, a location server, an LMF, etc.) may use at least one AI/ML model (e.g., the at least one AI/ML model 508) to determine the position of a UE or a target. For example, a UE may receive and measure PRSs transmitted from one or more base stations, and the UE may determine its position using an AI/ML model based on the PRS measurements. In another example, an LMF may receive PRS measurements from a UE or SRS measurements from a baes station, and the LMF may determine the position of the UE using an AI/ML model based on the PRS/SRS measurements.

FIG. 8B is a diagram 800B illustrating an example of AI/ML assisted positioning in accordance with various aspects of the present disclosure. As described in connection with FIGS. 5, 6A, and 7A, for AI/ML assisted positioning, a network node/entity (e.g., a UE, a base station, etc.) may use at least one AI/ML model (e.g., the at least one AI/ML model 508) to assist measurement of reference signals (e.g., PRS, SRS, etc.). Then, the network node/entity may transmit the reference signal measurements to a location server, such as an LMF. In response, the location server may determine the position of the UE based on a non-AI/ML mechanism/algorithm, or based on using an AI/ML model to determine the position of the UE. For example, a UE may receive and measure PRSs transmitted from one or more base stations, and the UE may transmit the PRS measurements to an LMF. The PRS measurements may include intermediate measurements, such as timing and/or angle of the PRSs, whether the PRSs are received based on a line-of-sight (LOS) condition or a non-line-of-sight (NLOS) condition, etc. Then, the LMF may determine the position of the UE based on the PRS measurements (e.g., the intermediate measurements) with or without using an AI/ML model. Similarly, a base station may receive and measure SRSs transmitted from a UE, and the baes station may transmit the SRS measurements to an LMF. Then, the LMF may determine the position of the UE based on the SRS measurements (e.g., the intermediate measurements) with or without using an AI/ML model.

In some implementations, one or more AI/ML models may be configured to be associated with at least one model identification/identifier (ID) and/or at least one model functionality ID (which may simply be referred to as a “functionality”). In addition, an ML feature name (MLFN) (or simply, feature, AI/ML-enabled feature) may be used to indicate different use cases of AI/ML (e.g., for positioning, CSI feedback, beam prediction, etc.). In some examples, a functionality may be mapped to an MLFN or an MLFN may have a functionality as a sub feature.

In some scenarios, it may be beneficial to associate model ID(s) and/or functionality ID(s) with specified use cases (e.g., AI/ML positioning use cases), such that a location server (e.g., an LMF) and a target (e.g., a UE) may have a common/better understanding how a model ID and/or a functionality maps to different DL-based deployment cases (e.g., as described in connection with FIGS. 5, 6A, and 6B) when there are different/multiple deployment cases for AI/ML positioning with DL based measurements. So far, most/current network implementations (e.g., LTE Positioning Protocol (LPP), NR Positioning Protocol A (NRPPa), etc.) have not specified how a model ID and/or a functionality may be communicated between the location server and the target.

Aspects presented herein may improve the performance and efficiency of AI/ML positioning by providing a signaling framework that enables a location server (e.g., an LMF) and a target (e.g., a UE) to recognize AI/ML model ID (which may also be referred to as AI/ML positioning ID in some examples) and/or AI/ML functionality (which may also be referred to as AI/ML functionality ID in some examples) for DL-based AI/ML positioning. For example, in one aspect of the present disclosure, an AI/ML positioning model may be assigned with a model ID and/or a functionality based on the representative use case, e.g., a first functionality (Functionality1) may be associated with direct AI/ML positioning, whereas a second functionality (Functionality2) may be associated with AI/ML assisted positioning, etc. In some implementations, a functionality may further be specified based on where the AI/ML model is implemented/running (e.g., at a UE, at a base station, or at an LMF, etc. as described in connection with FIGS. 5, 6A, and 6B). In some implementations, the functionality may also be specified based on AI/ML model input and/or output (e.g., direct AI/ML positioning with channel impulse response (CIR) model input, direct AI/ML positioning with reference signal received power (RSRP) model input, AI/ML assisted positioning with line-of-sight (LOS) identification output, AI/ML assisted positioning with ToA estimation output, etc.). In addition, for a given functionality, one or more AI/ML models may be identified and assigned with unique ID(s). Thus, one functionality may have multiple AI/ML models identified, where these AI/ML models may be configured to have different complexities, operational specifications, validity conditions, and/or performance guarantees, etc. An identified AI/ML model for a given AI/ML positioning functionality may also be assigned with several model realization IDs, where a realization (or a realization ID) of a given AI/ML model may serve as a set of parameter/model weights for the AI/ML model (e.g., to account for generalization to unseen/partially seen changes in a wireless environment).

In another aspect of the present disclosure, AI/ML model functionality ID(s), model ID(s), and/or model realization ID(s) may be configured to be standardized as part of a positioning procedure/protocol (e.g., LPP, NRPPa, etc.). For example, at least the functionality ID(s) or related description(s) may be specified to be standardized for a positioning procedure/protocol, and standardization of the model ID(s) and/or realization ID(s) may be configured to be optional for the positioning procedure/protocol depending on the source of the AI/ML model (e.g., UE-sources, network-sourced, etc.). A location server (e.g., an LMF) or a network may develop DL-based AI/ML positioning model(s) for UE-sided inference. Such a scenario may be represented with a given functionality ID and multiple supporting model IDs and/or realization IDs. In this scenario, a location server may share these AI/ML positioning model(s) along with their IDs with a target (e.g., a UE). In some implementations, standardization of the model ID and/or realization ID in a positioning procedure/protocol may also be optional depending on whether location server or network is involved with determination of selecting/switching/(de)activating the UE-sided AI/ML model.

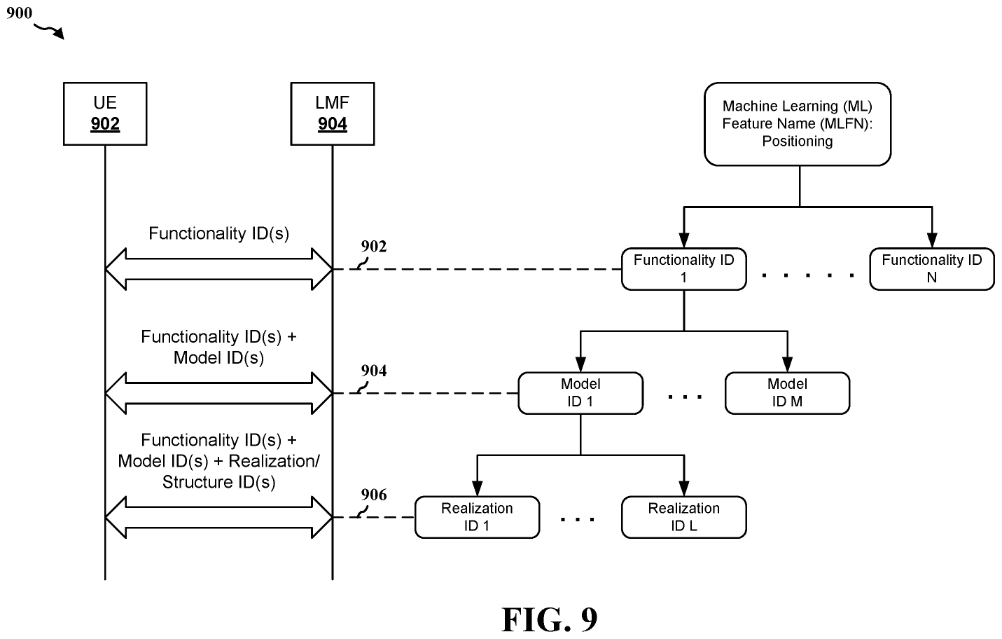

FIG. 9 is a diagram 900 illustrating an example hierarchy of an AI/ML positioning functionality and identification in accordance with various aspects of the present disclosure. A UE may indicate features and/or feature groups in which the UE lists conditions and parameters related to a functionality/model. An LMF may then identify a functionality that can be supported by the UE and enable this functionality/model related to AI/ML positioning. As shown at 902, a machine learning (ML) feature name (MLFN) may be associated with one or more functionality IDs, such as a first functionality ID (e.g., Functionality ID 1), a second functionality ID (e.g., Functionality ID 2), and up to an N^{th} functionality ID (e.g., Functionality ID N), etc. The one or more functionality IDs may be shared between a UE 902 (e.g., a target) and an LMF 904 (e.g., a location server, a core network, etc.), such that the UE 902 and the LMF 904 may have a common understanding/identification on AI/ML functionalit(ies) associated with the MLFN. In some implementations, as shown at 904, a functionality ID may further (or optionally) be associated with one or more model IDs, such as a first model ID (e.g., Model ID 1), a second model ID (e.g., Model ID 2), and up to an M^{th} model ID (e.g., Model ID M), etc. Similarly, the one or more model IDs may be shared between the UE 902 and the LMF 904, such that the UE 902 ant the LMF 904 may have a common understanding/identification on AI/ML model(s) associated with the MLFN (or a corresponding functionality). In some implementations, as shown at 906, a model ID may further (or optionally) be associated with one or more realization IDs (which may also be referred to as “structure IDs” in some examples), such as a first realization ID (e.g., Realization ID 1), a second realization ID (e.g., Realization ID 2), and up to an L^{th} realization ID (e.g., Realization ID L), etc. Similarly, the one or more realization IDs may be shared between the UE 902 and the LMF 904, such that the UE 902 ant the LMF 904 may have a common understanding/identification on realization(s)/structure(s) associated with the MLFN (or a corresponding AI/ML model).

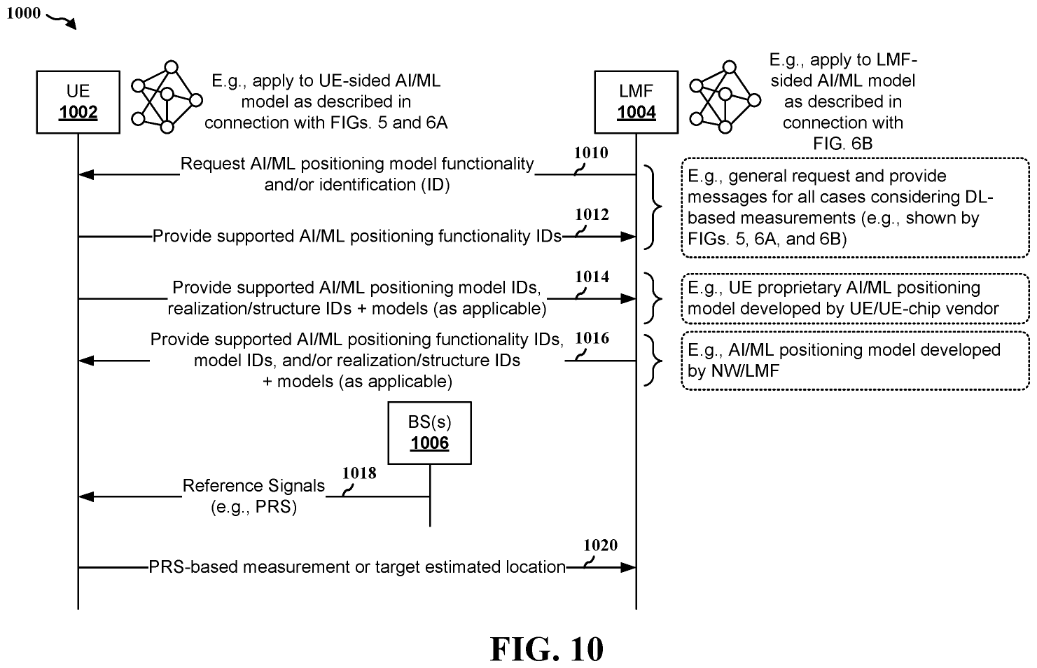

FIG. 10 is a communication flow 1000 illustrating an example of a target and a location server exchanging supported AI/ML positioning model functionality ID(s), model ID(s), and realization/model ID(s) in accordance with various aspects of the present disclosure. The numberings associated with the communication flow 1000 do not specify a particular temporal order and are merely used as references for the communication flow 1000.

At 1010, an LMF 1004 (e.g., a location server) may send a request to or for a UE 1002 (e.g., a target) to request/ask the UE 1002 to indicate a list of AI/ML positioning functionality IDs (or a list of features or feature groups related to a set of AI/ML positioning functionality IDs) supported by the UE 1002. For purposes of the present disclosure, when a first entity transmits a transmission (e.g., an indication, a configuration, a request, a data, etc.) “for” a second entity, it may indicate that the first entity is transmitting the transmission directly to the second entity, and/or that that the first entity is transmitting the transmission to the second entity via at least one other entity (e.g., a third entity). For example, when an LMF transmits a configuration/request for a UE, it may refer that the LMF is transmitting the configuration/request directly to the UE, or indirectly to the UE via another network node such as a base station. Table 2 and Table 3 below show examples of features or feature groups that may be related to AI/ML positioning functionality IDs.

TABLE 2
Examples of feature list for AI/ML positioning

| Features | Feature group |
|---|---|
| AI/ML_positioning | Direct_AIML_positioning_resource_configurations |
| AI/ML_positioning | AIML_assisted_positioning_resource_configurations |
| AI/ML_positioning | AIML_assisted_positioning_measurement_reporting |

TABLE 3
Examples of feature list for AI/ML positioning

| Features | Feature group |
|---|---|
| Direct_AI/ML_ | Direct_AIML_positioning_resource_ |
| positioning | configurations |
| AI/ML_assisted_ | AI/ML_assisted_positioning_resource_ |
| positioning | configurations |
| AI/ML_assisted_ | AI/ML_assisted_positioning_measurement_ |
| positioning | reporting |

At 1012, in response to the request from the LMF 1004, the UE 1002 may provide a list of supported AI/ML positioning functionality IDs (which may also be referred to or described as a list of supported features or feature groups associated with AI/ML positioning functionalities or functionality IDs) to the LMF 1004. In some examples, this signaling or communication exchange may be configured for a UE-sided AI/ML model as described in connection with FIGS. 5 and 6A. In one example, the request from the LMF 1004 at 1010 and the response from the UE 1002 at 1012 may be configured to be part of a positioning protocol procedure, such as during an LTE Positioning Protocol A (LPP) capability exchange procedure. In another example, the request and the response may be configured to be part of a new/defined/specified procedure (e.g., part of LPP) for indicating the AI/ML positioning model functionality and identification. In some implementations, the UE 1002 may also transmit, to the LMF 1004, (1) a list of flags/indications that indicates whether the UE 1002 has the capability to support functionality/functionalities with a proprietary model (e.g., a UE proprietary model); and/or a list of flags/indications that indicates the UE 1002 has the capability to run one or more functionalities using AI/ML model(s) developed by the LMF 1004 or a network (NW), which may be delivered to the UE 1002 from the LMF 1004 or the NW. In some examples, the LMF 1004 may also send the request via a broadcast messaging (e.g., the request is broadcasted to multiple UEs/targets), such as using or via a positioning system information block (PosSIB).

In one example, as shown at 1014, the UE 1002 may also (and optionally) transmit, to the LMF 1004, a list of model IDs for a given model functionality, such as described in connection with FIG. 9. In some implementations, the UE 1002 may also transmit the AI/ML model(s) (or configurations for the AI/ML models) associated with the list of model ID(s) to the LMF 1004 (e.g., if the LMF 1004 does not have these AI/ML models). For example, the AI/ML model implemented or run by the UE 1002 may be a proprietary model available at the UE 1002 (and not available at the LMF 1004). Similarly, the UE 1002 may also transmit a list of model realization/structure IDs that corresponds to a given model ID, such as described in connection with FIG. 9. Also, the UE 1002 may transmit the list of functionality IDs, the list of model IDs, and/or the list of realization/structure IDs via one message (e.g., via same signaling), or via multiple/separated messages (e.g., via multiple signaling).

At 1016, the LMF 1004 may transmit a set of AI/ML positioning functionalities (or a set of features or feature groups related to AI/ML positioning functionalities) supported by the LMF 1004. In some implementations, if an AI/ML model is implemented/configured at the UE 1002 (e.g., UE-sided AI/ML model), such as described in connection with FIGS. 5 and 6A, the AI/ML model may be provided by the LMF 1004 or an NW (which may be referred to as an LMF-provided/developed AI/ML model or an NW provided/developed AI/ML model). Then, in some examples, at 1016, the LMF 1004 may also transmit, to or for the UE 1002, a list of model IDs for a given model functionality and also the corresponding AI/ML model(s) as applicable. The LMF 1004 may also transmit a list of realization/structure IDs that corresponds to a given model ID to be run at the UE 1002 if available and applicable. In some examples, such configuration may specify assumption that the UE 1002 supports the AI/ML positioning functionality ID for which the model ID(s) and the realization/structure ID(s) are indicated. In one example, the LMF 1004 may transmit the list of model IDs for a given model functionality and/or the list of realization/structure IDs that corresponds to a given model ID as part of a positioning protocol procedure, such as during an LPP assistance data (AD) exchange procedure. In another example, the LMF 1004 may transmit the list of model IDs and/or the list of realization/structure IDs as part of a new/defined/specified procedure (e.g., part of LPP) for indicating the AI/ML positioning model functionality and identification for LMF-provided/developed AI/ML model(S) and/or NW provided/developed AI/ML model(s). In some examples, the LMF 1004 may also send the request via a broadcast messaging (e.g., the request is broadcasted to multiple UEs/targets), such as using or via a PosSIB.

In another aspect of the present disclosure, if an AI/ML model is implemented/configured at the LMF 1004 (e.g., LMF-sided AI/ML model), such as described in connection with FIG. 6B, at 1010, the LMF 1004 may send a request, to or for the UE 1002, inquiring/asking the UE 1002 whether the UE 1002 has the capability to support AI/ML positioning functionality ID(s) for which the AI/ML model runs at the LMF 1004. The LMF 1004 may also request or specify measurements (e.g., positioning related measurements such as DL-PRS measurements) to be performed or provided by the UE 1002 (e.g., RSRP, AoA, TDOA for a set of PRS, etc.). Then, at 1012, in response to the request from the LMF 1004, the UE 1002 may provide a list of supported AI/ML positioning functionality IDs to the LMF 1004 (which may also be referred to or described as a list of supported features or feature groups associated with AI/ML positioning functionalities or functionality IDs), where a functionality ID in the list of supported AI/ML positioning functionality IDs may indicate type of measurements the UE 1002 is capable of performing and/or providing for the LMF 1004 (e.g., the AI/ML model input type). Similarly, the request from the LMF 1004 at 1010 and the response from the UE 1002 at 1012 may be configured to be part of a positioning protocol procedure, such as during an LTE Positioning Protocol A (LPP) capability exchange procedure, and/or the request and the response may be configured to be part of a new/defined/specified procedure (e.g., part of LPP) for indicating the AI/ML positioning model functionality and identification. In some examples, the LMF 1004 may also send the request via a broadcast messaging (e.g., the request is broadcasted to multiple UEs/targets), such as using or via a PosSIB.

At 1018, the UE 1002 may receive a set of reference signals (RSs) from one or more base stations 1006 (and/or TRPs), such as a set of PRSs, and the UE 1002 may preform positioning measurements for the set of RSs, such as described in connection with FIG. 4.

At 1020, the UE 1002 may transmit PRS-based measurement(s) to the LMF 1004 if the LMF 1004 is configured to determine the location of the UE 1002 (e.g., UE-assisted positioning), or the UE 1002 may transmit an estimated location of the UE 1002 (determined based on the measurement of the set of RSs from the one or more base stations 1018), such as described in connection with FIG. 4. Also, as described in connection with FIGS. 5, 6A, and 6B, the measurement for the set of RSs and/or the estimation for the location of the UE 1002 may be performed using at least one AI/ML model (e.g., based on AI/ML) positioning, where the at least one AI/ML model may be associated with the functionality ID(s), model ID(s), and/or realization/structure ID(S) supported by the UE 1002 and/or the LMF 1004. For example, for UE-sided AI/ML model as described in connection with FIG. 5, the UE 1002 may measure the set of RSs using or with an assistance from an AI/ML model that is associated with at least one functionality ID supported by the UE 1002. In another example, the UE 1002 may estimate its location using or with an assistance from an AI/ML model that is associated with at least one functionality ID supported by the UE 1002.

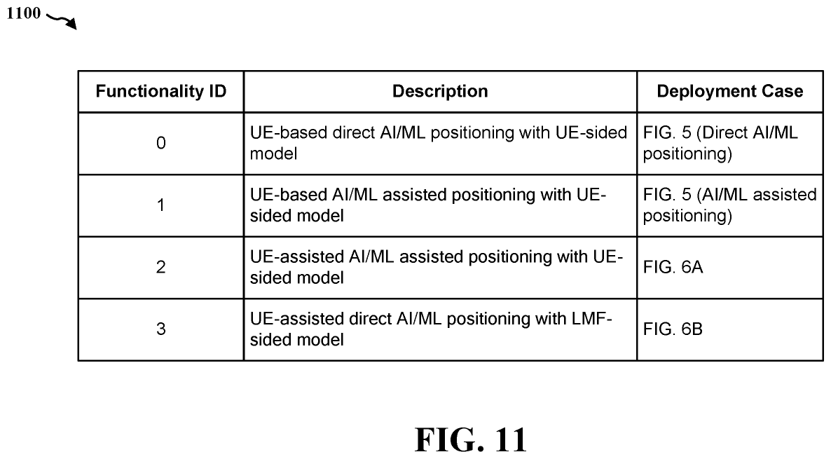

In one aspect of the present disclosure, the DL-based AI/ML positioning functionality IDs may be specified based on deployment cases, such as shown by a diagram 1100 of FIG. 11. For example, a first functionality ID (e.g., Functionality ID 0) may correspond to a UE-based direct AI/ML positioning with UE-sided model as described in connection with FIG. 5 (for direct AI/ML positioning), a second functionality ID (e.g., Functionality ID 1) may correspond to a UE-based AI/ML assisted positioning with UE-sided model as described in connection with FIG. 5 (for AI/ML assisted positioning), a third functionality ID (e.g., Functionality ID 2) may correspond to a UE-assisted AI/ML assisted positioning with UE-sided model as described in connection with FIG. 6A, and a fourth functionality ID (e.g., Functionality ID 3) may correspond to UE-assisted direct AI/ML positioning with LMF-sided model as described in connection with FIG. 6B, etc.

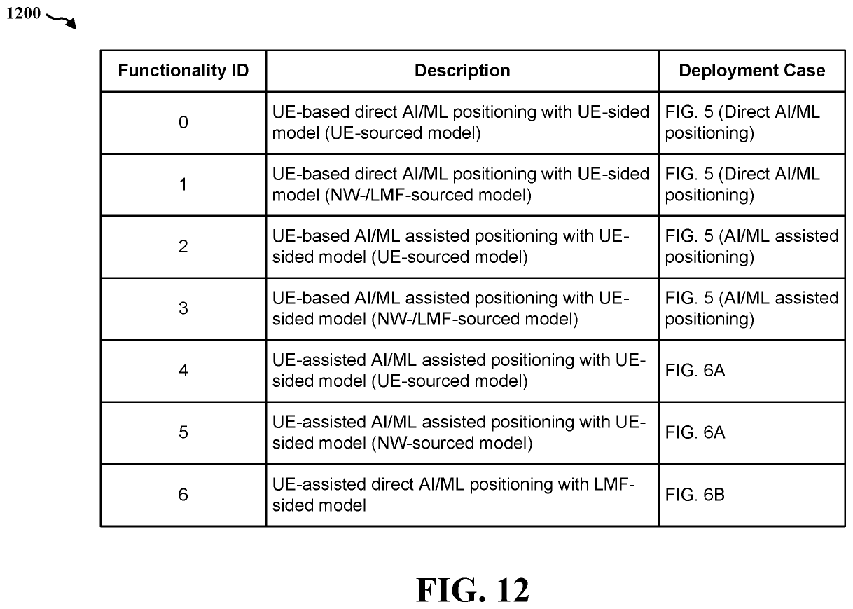

In another aspect of the present disclosure, the DL-based AI/ML positioning functionality IDs may be specified based on deployment cases along with AI/ML model source indication (e.g., UE-sourced vs. NW-/LMF-sourced), such as shown by a diagram 1200 of FIG. 12. For example, a first functionality ID (e.g., Functionality ID 0) may correspond to a UE-based direct AI/ML positioning with UE-sided model (UE-sourced model) as described in connection with FIG. 5 (for direct AI/ML positioning), a second functionality ID (e.g., Functionality ID 1) may correspond to a UE-based direct AI/ML positioning with UE-sided model (NW-/LMF-sourced model) as described in connection with FIG. 5 (for direct AI/ML positioning), a third functionality ID (e.g., Functionality ID 2) may correspond to a UE-based AI/ML assisted positioning with UE-sided model (UE-sourced model) as described in connection with FIG. 5 (for AI/ML assisted positioning), a fourth functionality ID (e.g., Functionality ID 3) may correspond to a UE-based AI/ML assisted positioning with UE-sided model (NW-/LMF-sourced model) as described in connection with FIG. 5 (for AI/ML assisted positioning), a fifth functionality ID (e.g., Functionality ID 4) may correspond to a UE-assisted AI/ML assisted positioning with UE-sided model (UE-sourced model) as described in connection with FIG. 6A, a sixth functionality ID (e.g., Functionality ID 5) may correspond to a UE-assisted AI/ML assisted positioning with UE-sided model (NW-sourced model) as described in connection with FIG. 6A, and a seventh functionality ID (e.g., Functionality ID 6) may correspond to a UE-assisted direct AI/ML positioning with LMF-sided model as described in connection with FIG. 6B, etc.

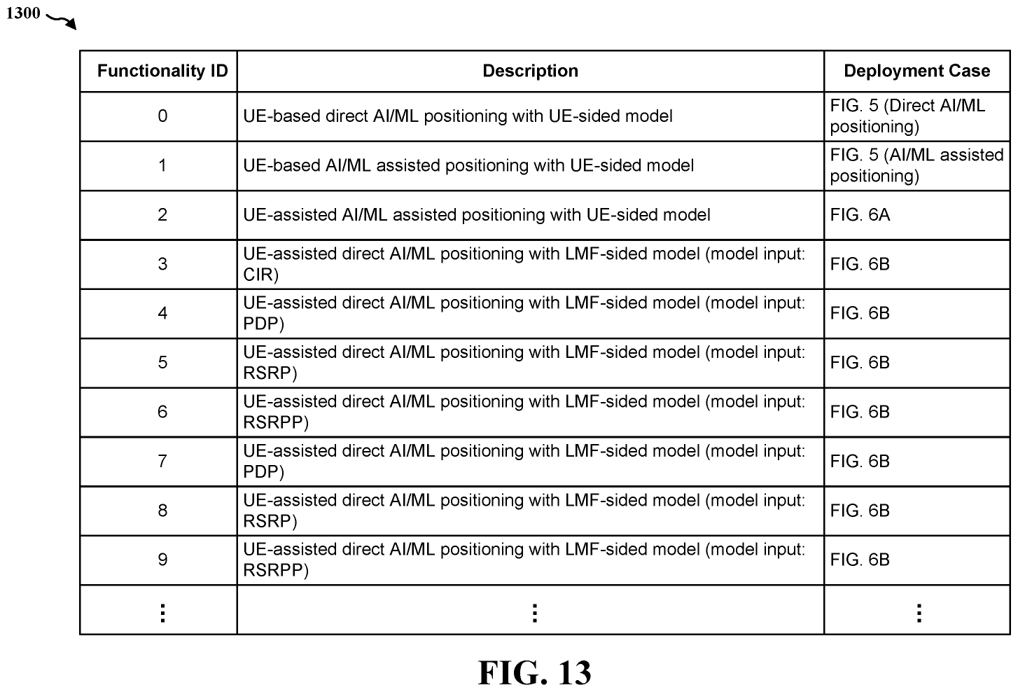

In another aspect of the present disclosure, the DL-based AI/ML positioning functionality IDs may be specified based on deployment cases along with model input description, such as shown by a diagram 1300 of FIG. 13. The model input(s) may be channel impulse response (CIR), power delay profile (PDP), delay profile (DP), channel frequency response (CFR), truncated CIR, PDP, DP, or CFR, subsampled CIR, PDP, DP, or CFR, autocorrelation/cross correlation of CIRs/CFRs received from different transmission reception points (TRPs), reference signal received power (RSRP), reference signal received path power (RSRPP), angle of departure (AoD), time of arrival (ToA)/reference signal time difference (RSTD), soft information of ToA/RSTD, soft information of angles, line-of-sight (LOS)/non-line-of-sight (NLOS) identification, soft information of LOS state, etc. Soft information may refer to a probability, a likelihood, or parameters for a probability distribution, etc. For example, a third functionality ID (e.g., Functionality ID 2) may correspond to a UE-assisted AI/ML assisted positioning with UE-sided model as described in connection with FIG. 6A, and a fifth functionality ID (e.g., Functionality ID 4) may correspond to a UE-assisted direct AI/ML positioning with LMF-sided model (model input: PDP) as described in connection with FIG. 6B, etc.

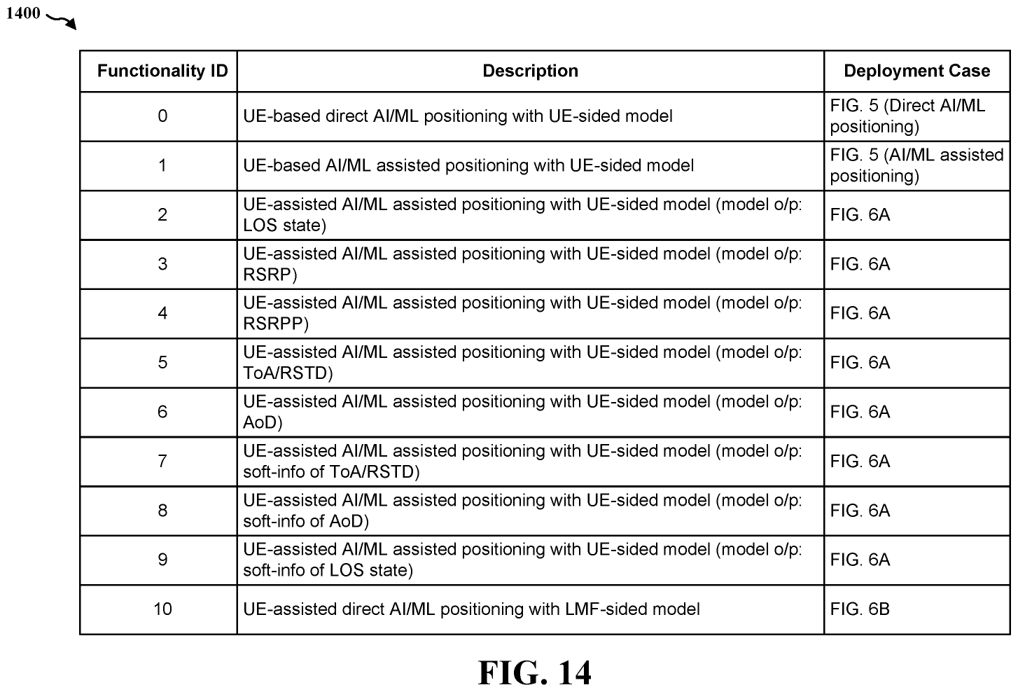

In another aspect of the present disclosure, the DL-based AI/ML positioning functionality IDs may be specified based on deployment cases along with model output description (e.g., when applicable for AI/ML assisted positioning), such as shown by a diagram 1400 of FIG. 14. The model output(s) may be RSRP, RSRPP, angle of departure (AoD), ToA/RSTD, soft information of ToA/RSTD, soft information of angles, LOS/NLOS identification, soft information of LOS state, etc. For example, a fourth functionality ID (e.g., Functionality ID 3) may correspond to a UE-assisted AI/ML assisted positioning with UE-sided model (model output (o/p): RSRP) as described in connection with FIG. 6A, a seventh functionality ID (e.g., Functionality ID 6) may correspond to a UE-assisted AI/ML assisted positioning with UE-sided model (model output: AoD) as described in connection with FIG. 6A, and an eleventh functionality ID (e.g., Functionality ID 10) may correspond to a UE-assisted direct AI/ML positioning with LMF-sided model as described in connection with FIG. 6B, etc.

In another aspect of the present disclosure, the DL-based AI/ML positioning functionality IDs may be specified based on deployment cases along with model complexity (e.g., model computation/latency in relation to (e.g., versus) achieved accuracy), a validity condition (e.g., clutter settings, deployment scenario, etc.), and/or operational specifications (e.g., specified PRS configurations). Also, a given functionality ID may have multiple supporting model IDs, which may include different parameter weights to account for generalization.

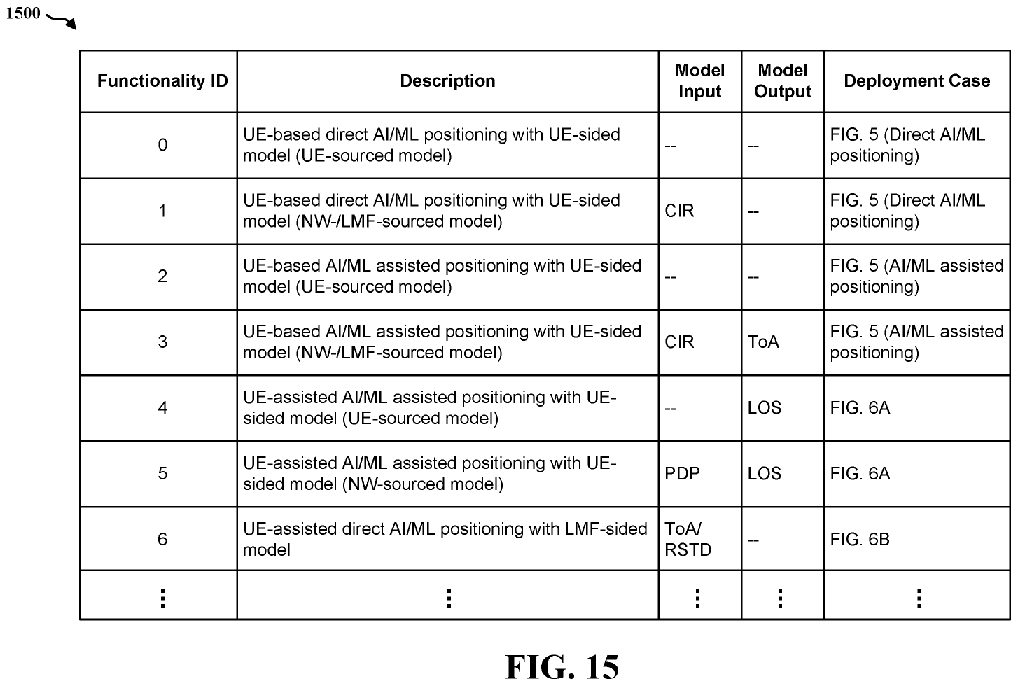

In another aspect of the present disclosure, the DL-based AI/ML positioning functionality IDs may be specified based on the combination of deployment cases described above and in connection with FIGS. 11 to 14. In other words, the DL-based AI/ML positioning functionality IDs may be specified based on deployment cases, a model source indication, a model input description, a model output description, a model complexity, a validity condition, operational specifications, or a combination thereof. For example, the DL-based AI/ML positioning functionality IDs may be associated with an indication of deployment cases along with model source, model input type, and model output types description. For example, as shown by a diagram 1500 of FIG. 15, a fourth functionality ID (e.g., Functionality ID 3) may correspond to a UE-based AI/ML assisted positioning with UE-sided model (NW-/LMF-sourced model) with CIR as model input and ToA as model output as described in connection with FIG. 5, and a sixth functionality ID (e.g., Functionality ID 5) may correspond to a UE-assisted AI/ML assisted positioning with UE-sided model (NW-sourced model) with PDP as model input and LOS (or LOS indication) as model output as described in connection with FIG. 5.

In another aspect of the present disclosure, similarly, the DL-based AI/ML positioning model IDs may be specified based on a model complexity (e.g., model computation/latency in relation to (or versus) achieved accuracy), a validity condition (e.g., clutter settings, deployment scenario, etc.), and/or operational specifications (e.g., specified PRS configurations). Also, a given model ID may have multiple supporting realization IDs (e.g., different parameter weights to account for generalization).

In another aspect of the present disclosure, the DL-based AI/ML positioning model IDs may be specified based on a model complexity (e.g., model computation/latency vs. achieved accuracy), a validity condition (e.g., clutter settings, deployment scenario, etc.), and/or operational specifications (e.g., specified PRS configurations). Also, a given model ID may have multiple supporting realization IDs (e.g., different parameter weights to account for generalization).

As an LMF and a UE may specify consistent AI/ML model IDs that represent different DL-based AI/ML positioning scenarios, in an embodiment, a positioning AI/ML model may be assigned with an ID based on different factors like—direct or assisted AI/ML positioning, location of the model, model inputs and outputs, etc. In an embodiment, an LMF may request a target to indicate the positioning AI/ML model IDs that it supports as part of an LPP capability exchange procedure or a new procedure. In an embodiment, where LMF or NW provide the positioning AI/ML model, the LMF may send to a target a list of IDs for a given model functionality or model IDs to be run at the target as part of an LPP assistance data exchange procedure or a new procedure.

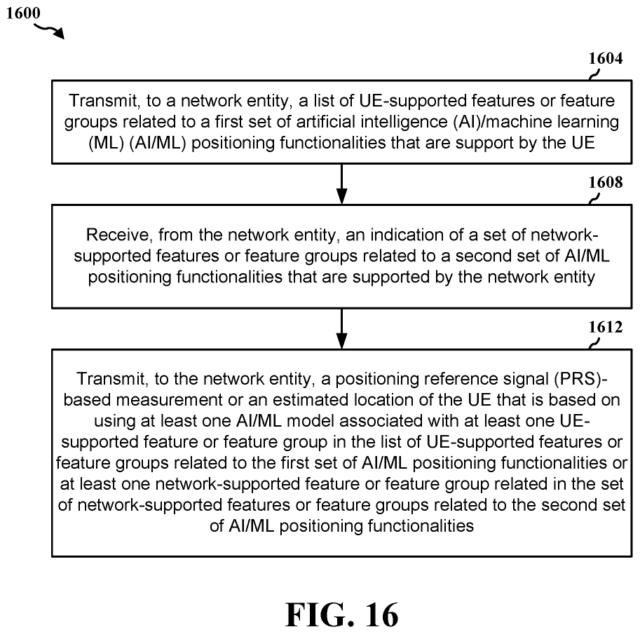

FIG. 16 is a flowchart 1600 of a method of wireless communication. The method may be performed by a UE (e.g., the UE 104, 404, 902, 1002; the apparatus 1804). The method may enable the UE to exchange AI/ML model functionalities and identifications with a location server (e.g., an LMF), such that the UE and the location server may have a common understanding for AI/ML models used in association with AI/ML positioning, thereby improving the performance and efficiency of AI/ML positioning.

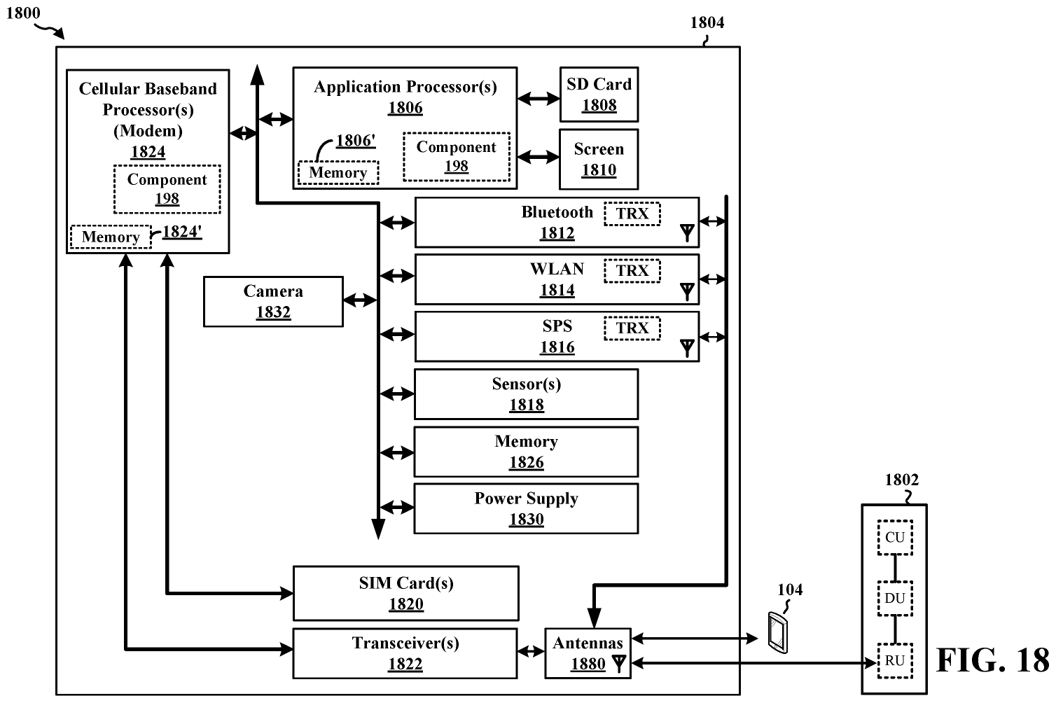

At 1604, the UE may transmit, to a network entity, a list of UE-supported features or feature groups related to a first set of AI/ML positioning functionalities (and/or models) that are support by the UE, such as described in connection with FIG. 10. For example, at 1012, the UE 1002 may provide a list of supported AI/ML positioning functionality IDs (which may also be referred to or described as a list of supported features or feature groups associated with AI/ML positioning functionalities or functionality IDs) to the LMF 1004. The transmission of the list may be performed by, e.g., the positioning functionality exchange component 198, the transceiver(s) 1822, the cellular baseband processor(s) 1824, and/or the application processor(s) 1806 of the apparatus 1804 in FIG. 18.

At 1608, the UE may receive, from the network entity, an indication of a set of network-supported features or feature groups related to a second set of AI/ML positioning functionalities that are supported by the network entity, such as described in connection with FIG. 10. For example, at 1016, the UE 1002 may receive, from the LMF 1004, a set of AI/ML positioning functionalities (or a set of features or feature groups related to AI/ML positioning functionalities) supported by the LMF 1004. The reception of the indication may be performed by, e.g., the positioning functionality exchange component 198, the transceiver(s) 1822, the cellular baseband processor(s) 1824, and/or the application processor(s) 1806 of the apparatus 1804 in FIG. 18.

In one example, each UE-supported feature or feature group in the list of UE-supported features or feature groups related to the first set of AI/ML positioning functionalities may be associated with a functionality ID. In some implementations, each UE-supported feature or feature group in the list of UE-supported features or feature groups related to the first set of AI/ML positioning functionalities may be further associated with at least one of a model ID, a realization ID, or a structure ID.

In another example, each network-supported feature or feature group in the set of network-supported features or feature groups related to the second set of AI/ML positioning functionalities may be associated with a functionality ID. In some implementations, each network-supported feature or feature group in the set of network-supported features or feature groups related to the second set of AI/ML positioning functionalities may be further associated with at least one of a model ID, a realization ID, or a structure ID.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with direct AI/ML positioning or AI/ML assisted positioning.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning may be executed at the UE, at the network entity, or at a network node.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with at least one of an AI/ML model input or an AI/ML model output.

In another example, the UE may receive, from the network entity, a request to provide the list of UE-supported features or feature groups related to the first set of AI/ML positioning functionalities, where the list of UE-supported features or feature groups related to the first set of AI/ML positioning functionalities is transmitted based on the request, such as described in connection with FIG. 10. For example, at 1010, the UE 1002 may receive a request from the LMF 1004 requesting/asking the UE 1002 to indicate a list of AI/ML positioning functionality IDs (or a list of features or feature groups related to a set of AI/ML positioning functionality IDs) supported by the UE 1002. The reception of the request may be performed by, e.g., the positioning functionality exchange component 198, the transceiver(s) 1822, the cellular baseband processor(s) 1824, and/or the application processor(s) 1806 of the apparatus 1804 in FIG. 18.

In another example, the UE may transmit, to the network entity, a list of indications indicating whether the UE supports one or more functionalities associated with an AI/ML model.

In another example, the UE may receive, from the network entity, a query of whether the UE is capable of executing one or more functionalities associated with an AI/ML model provided by the network entity or a network node.

In another example, the UE may receive, from the network entity, an inquiry of whether the UE is capable of performing the PRS-based measurement using one or more network-supported features or feature groups related to AI/ML positioning functionalities

In another example, the UE may transmit, to the network entity, one or more indications of AI/ML models associated with the list of UE-supported features or feature groups related to the first set of AI/ML positioning functionalities, such as described in connection with FIG. 10. For example, as shown at 1014, the UE 1002 may also (and optionally) transmit, to the LMF 1004, a list of model IDs for a given model functionality. In some implementations, the UE 1002 may also transmit the AI/ML model(s) (or configurations for the AI/ML models) associated with the list of model ID(s) to the LMF 1004. The reception of the request may be performed by, e.g., the positioning functionality exchange component 198, the transceiver(s) 1822, the cellular baseband processor(s) 1824, and/or the application processor(s) 1806 of the apparatus 1804 in FIG. 18. In some implementations, the UE may transmit, to the network entity, a configuration for AI/ML-based positioning based on the list of UE-supported features or feature groups related to the first set of AI/ML positioning functionalities or the AI/ML models.

In another example, the UE may receive, from the network entity, one or more indications of AI/ML models associated with the set of network-supported features or feature groups related to the second set of AI/ML positioning functionalities, such as described in connection with FIG. 10. For example, at 1016, if an AI/ML model is implemented/configured at the UE 1002 (e.g., UE-sided AI/ML model), the AI/ML model may be provided by the LMF 1004. Thus, the UE 1002 may receive, from the LMF 1004, a list of model IDs for a given model functionality and also the corresponding AI/ML model(s) as applicable. The reception of the one or more indications may be performed by, e.g., the positioning functionality exchange component 198, the transceiver(s) 1822, the cellular baseband processor(s) 1824, and/or the application processor(s) 1806 of the apparatus 1804 in FIG. 18. In some implementations, the UE may receive, from the network entity, a configuration for AI/ML-based positioning based on the set of network-supported features or feature groups related to the second set of AI/ML positioning functionalities or the AI/ML models.

At 1612, the UE may transmit, to the network entity, a PRS-based measurement or an estimated location of the UE that is based on using at least one AI/ML model associated with at least one UE-supported feature or feature group in the list the list of UE-supported features or feature groups related to the first set of AI/ML positioning functionalities or at least one network-supported feature or feature group in the set of network-supported features or feature groups related to the second set of AI/ML positioning functionalities, such as described in connection with FIG. 10. For example, at 1020, the UE 1002 may transmit PRS-based measurement(s) to the LMF 1004 if the LMF 1004 is configured to determine the location of the UE 1002 (e.g., UE-assisted positioning), or the UE 1002 may transmit an estimated location of the UE 1002 (determined based on the measurement of the set of RSs from the one or more base stations 1018), such as described in connection with FIG. 4. The measurement for the set of RSs and/or the estimation for the location of the UE 1002 may be performed using at least one AI/ML model (e.g., based on AI/ML) positioning, where the at least one AI/ML model may be associated with the functionality ID(s), model ID(s), and/or realization/structure ID(S) supported by the UE 1002 and/or the LMF 1004. The transmission of the PRS-based measurement and/or the estimated location of the UE may be performed by, e.g., the positioning functionality exchange component 198, the transceiver(s) 1822, the cellular baseband processor(s) 1824, and/or the application processor(s) 1806 of the apparatus 1804 in FIG. 18.

In one example, the UE may perform at least one of (1) a measurement of a set of positioning reference signals (PRSs) from at least one network node, or (2) an estimation of a location of the UE using one or more AI/ML models. In some implementations, the at least one network node may be a base station and the network entity is a location server or an LMF.

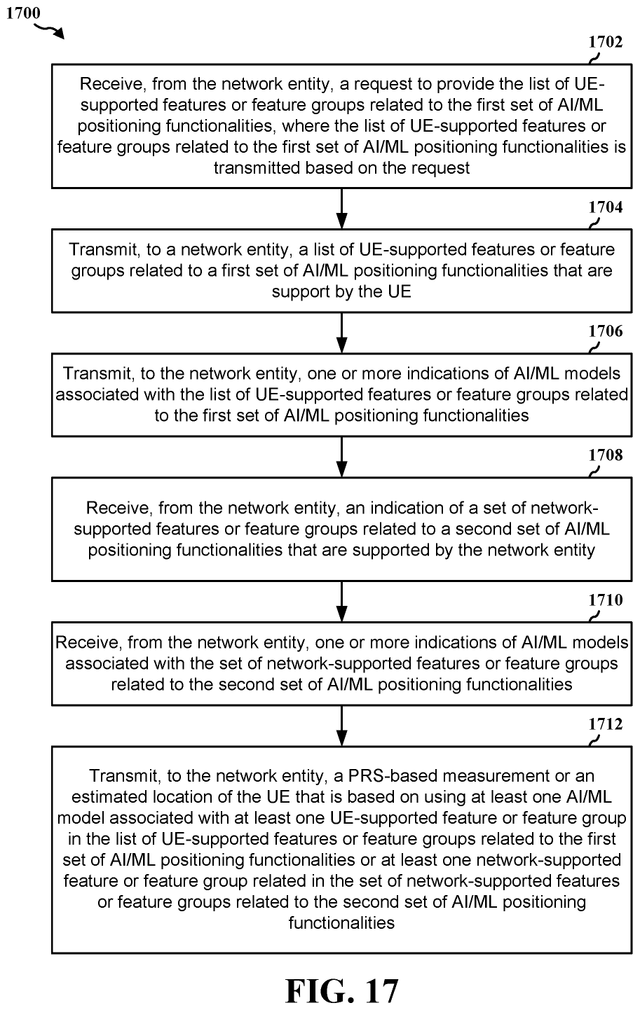

FIG. 17 is a flowchart 1700 of a method of wireless communication. The method may be performed by a UE (e.g., the UE 104, 404, 902, 1002; the apparatus 1804). The method may enable the UE to exchange AI/ML model functionalities and identifications with a network entity (e.g., a location server, an LMF, etc.), such that the UE and the network entity may have a common understanding for AI/ML models used in association with AI/ML positioning, thereby improving the performance and efficiency of AI/ML positioning.

At 1702, the UE may receive, from the network entity, a request to provide the list of UE-supported features or feature groups related to the first set of AI/ML positioning functionalities, where the list of UE-supported features or feature groups related to the first set of AI/ML positioning functionalities is transmitted based on the request, such as described in connection with FIG. 10. For example, at 1010, the UE 1002 may receive a request from the LMF 1004 requesting/asking the UE 1002 to indicate a list of AI/ML positioning functionality IDs (or a list of features or feature groups related to a set of AI/ML positioning functionality IDs) supported by the UE 1002. The reception of the request may be performed by, e.g., the positioning functionality exchange component 198, the transceiver(s) 1822, the cellular baseband processor(s) 1824, and/or the application processor(s) 1806 of the apparatus 1804 in FIG. 18.

In one example, the UE may transmit, to the network entity, a list of indications indicating whether the UE supports one or more functionalities associated with an AI/ML model.

In another example, the UE may receive, from the network entity, a query of whether the UE is capable of executing one or more functionalities associated with an AI/ML model provided by the network entity or a network node.

In another example, the UE may receive, from the network entity, an inquiry of whether the UE is capable of performing the PRS-based measurement using one or more network-supported features or feature groups related to AI/ML positioning functionalities.

At 1704, the UE may transmit, to a network entity, a list of UE-supported features or feature groups related to a first set of AI/ML positioning functionalities (and/or models) that are support by the UE, such as described in connection with FIG. 10. For example, at 1012, the UE 1002 may provide a list of supported AI/ML positioning functionality IDs (which may also be referred to or described as a list of supported features or feature groups associated with AI/ML positioning functionalities or functionality IDs) to the LMF 1004. The transmission of the list may be performed by, e.g., the positioning functionality exchange component 198, the transceiver(s) 1822, the cellular baseband processor(s) 1824, and/or the application processor(s) 1806 of the apparatus 1804 in FIG. 18.

At 1706, the UE may transmit, to the network entity, one or more indications of AI/ML models associated with the list of UE-supported features or feature groups related to the first set of AI/ML positioning functionalities, such as described in connection with FIG. 10. For example, as shown at 1014, the UE 1002 may also (and optionally) transmit, to the LMF 1004, a list of model IDs for a given model functionality. In some implementations, the UE 1002 may also transmit the AI/ML model(s) (or configurations for the AI/ML models) associated with the list of model ID(s) to the LMF 1004. The transmission of the one or more indications may be performed by, e.g., the positioning functionality exchange component 198, the transceiver(s) 1822, the cellular baseband processor(s) 1824, and/or the application processor(s) 1806 of the apparatus 1804 in FIG. 18. In some implementations, the UE may transmit, to the network entity, a configuration for AI/ML-based positioning based on the list of UE-supported features or feature groups related to the first set of AI/ML positioning functionalities or the AI/ML models.

At 1708, the UE may receive, from the network entity, an indication of a set of network-supported features or feature groups related to a second set of AI/ML positioning functionalities that are supported by the network entity, such as described in connection with FIG. 10. For example, at 1016, the UE 1002 may receive, from the LMF 1004, a set of AI/ML positioning functionalities (or a set of features or feature groups related to AI/ML positioning functionalities) supported by the LMF 1004. The reception of the indication may be performed by, e.g., the positioning functionality exchange component 198, the transceiver(s) 1822, the cellular baseband processor(s) 1824, and/or the application processor(s) 1806 of the apparatus 1804 in FIG. 18.

At 1710, the UE may receive, from the network entity, one or more indications of AI/ML models associated with the set of network-supported features or feature groups related to the second set of AI/ML positioning functionalities, such as described in connection with FIG. 10. For example, at 1016, if an AI/ML model is implemented/configured at the UE 1002 (e.g., UE-sided AI/ML model), the AI/ML model may be provided by the LMF 1004. Thus, the UE 1002 may receive, from the LMF 1004, a list of model IDs for a given model functionality and also the corresponding AI/ML model(s) as applicable. The reception of the one or more indications may be performed by, e.g., the positioning functionality exchange component 198, the transceiver(s) 1822, the cellular baseband processor(s) 1824, and/or the application processor(s) 1806 of the apparatus 1804 in FIG. 18. In some implementations, the UE may receive, from the network entity, a configuration for AI/ML-based positioning based on the set of network-supported features or feature groups related to the second set of AI/ML positioning functionalities or the AI/ML models.

In one example, each UE-supported feature or feature group in the list of UE-supported features or feature groups related to the first set of AI/ML positioning functionalities may be associated with a functionality ID. In some implementations, each UE-supported feature or feature group in the list of UE-supported features or feature groups related to the first set of AI/ML positioning functionalities may be further associated with at least one of a model ID, a realization ID, or a structure ID.

In another example, each network-supported feature or feature group in the set of network-supported features or feature groups related to the second set of AI/ML positioning functionalities may be associated with a functionality ID. In some implementations, each network-supported feature or feature group in the set of network-supported features or feature groups related to the second set of AI/ML positioning functionalities may be further associated with at least one of a model ID, a realization ID, or a structure ID.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with direct AI/ML positioning or AI/ML assisted positioning.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning may be executed at the UE, at the network entity, or at a network node.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with at least one of an AI/ML model input or an AI/ML model output.

At 1712, the UE may transmit, to the network entity, a PRS-based measurement or an estimated location of the UE that is based on using at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities, such as described in connection with FIG. 10. For example, at 1020, the UE 1002 may transmit PRS-based measurement(s) to the LMF 1004 if the LMF 1004 is configured to determine the location of the UE 1002 (e.g., UE-assisted positioning), or the UE 1002 may transmit an estimated location of the UE 1002 (determined based on the measurement of the set of RSs from the one or more base stations 1018), such as described in connection with FIG. 4. The measurement for the set of RSs and/or the estimation for the location of the UE 1002 may be performed using at least one AI/ML model (e.g., based on AI/ML) positioning, where the at least one AI/ML model may be associated with the functionality ID(s), model ID(s), and/or realization/structure ID(S) supported by the UE 1002 and/or the LMF 1004. The transmission of the PRS-based measurement and/or the estimated location of the UE may be performed by, e.g., the positioning functionality exchange component 198, the transceiver(s) 1822, the cellular baseband processor(s) 1824, and/or the application processor(s) 1806 of the apparatus 1804 in FIG. 18.

In one example, the UE may perform at least one of (1) a measurement of a set of positioning reference signals (PRSs) from at least one network node, or (2) an estimation of a location of the UE using one or more AI/ML models. In some implementations, the at least one network node may be a base station and the network entity is a location server or a location management function (LMF).

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor 1824 (also referred to as a modem) coupled to one or more transceivers 1822 (e.g., cellular RF transceiver). The cellular baseband processor(s) 1824 may include at least one on-chip memory 1824′. In some aspects, the apparatus 1804 may further include one or more subscriber identity modules (SIM) cards 1820 and at least one application processor 1806 coupled to a secure digital (SD) card 1808 and a screen 1810. The application processor(s) 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; ultrawide band (UWB) sensor, motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor(s) 1824 communicates through the transceiver(s) 1822 via one or more antennas 1880 with the UE 104 and/or with an RU associated with a network entity 1802. The cellular baseband processor(s) 1824 and the application processor(s) 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor(s) 1824 and the application processor(s) 1806 are each responsible for general processing, including the execution of software stored on the computer-readable medium/memory. The software, when executed by the cellular baseband processor(s) 1824/application processor(s) 1806, causes the cellular baseband processor(s) 1824/application processor(s) 1806 to perform the various functions described supra. The computer-readable medium/memory may also be used for storing data that is manipulated by the cellular baseband processor(s) 1824/application processor(s) 1806 when executing software. The cellular baseband processor(s) 1824/application processor(s) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) 1824 and/or the application processor(s) 1806, and in another configuration, the apparatus 1804 may be the entire UE (e.g., see UE 350 of FIG. 3) and include the additional modules of the apparatus 1804.

As discussed supra, the positioning functionality exchange component 198 may be configured to transmit, to a network entity, a list of UE-supported features or feature groups related to a first set of AI/ML positioning functionalities that are support by the UE. The positioning functionality exchange component 198 may also be configured to receive, from the network entity, an indication of a set of network-supported features or feature groups related to a second set of AI/ML positioning functionalities that are supported by the network entity. The positioning functionality exchange component 198 may also be configured to transmit, to the network entity, a PRS-based measurement or an estimated location of the UE that is based on using at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities The positioning functionality exchange component 198 may be within the cellular baseband processor(s) 1824, the application processor(s) 1806, or both the cellular baseband processor(s) 1824 and the application processor(s) 1806. The positioning functionality exchange component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) 1824 and/or the application processor(s) 1806, may include means for transmitting, to a network entity, a list of UE-supported features or feature groups related to a first set of AI/ML positioning functionalities that are support by the UE. The apparatus 1804 may further include means for receiving, from the network entity, an indication of a set of network-supported features or feature groups related to a second set of AI/ML positioning functionalities that are supported by the network entity. The apparatus 1804 may further include means for transmitting, to the network entity, a PRS-based measurement or an estimated location of the UE that is based on using at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

In one configuration, each UE-supported feature or feature group in the list of UE-supported features or feature groups related to the first set of AI/ML positioning functionalities may be associated with a functionality ID. In some implementations, each UE-supported feature or feature group in the list of UE-supported features or feature groups related to the first set of AI/ML positioning functionalities may be further associated with at least one of a model ID, a realization ID, or a structure ID.

In another configuration, each network-supported feature or feature group in the set of network-supported features or feature groups related to the second set of AI/ML positioning functionalities may be associated with a functionality ID. In some implementations, each network-supported feature or feature group in the set of network-supported features or feature groups related to the second set of AI/ML positioning functionalities may be further associated with at least one of a model ID, a realization ID, or a structure ID.

In another configuration, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with direct AI/ML positioning or AI/ML assisted positioning.

In another configuration, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning may be executed at the UE, at the network entity, or at a network node.

In another configuration, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with at least one of an AI/ML model input or an AI/ML model output.

In another configuration, the apparatus 1804 may further include means for receiving, from the network entity, a request to provide the list of UE-supported features or feature groups related to the first set of AI/ML positioning functionalities, where the list of UE-supported features or feature groups related to the first set of AI/ML positioning functionalities is transmitted based on the request.

In another configuration, the apparatus 1804 may further include means for transmitting, to the network entity, a list of indications indicating whether the UE supports one or more functionalities associated with an AI/ML model.

In another configuration, the apparatus 1804 may further include means for receiving, from the network entity, a query of whether the UE is capable of executing one or more functionalities associated with an AI/ML model provided by the network entity or a network node.

In another configuration, the apparatus 1804 may further include means for receiving, from the network entity, an inquiry of whether the UE is capable of performing the PRS-based measurement using one or more network-supported features or feature groups related to AI/ML positioning functionalities

In another configuration, the apparatus 1804 may further include means for transmitting, to the network entity, one or more indications of AI/ML models associated with the list of UE-supported features or feature groups related to the first set of AI/ML positioning functionalities. In some implementations, the apparatus 1804 may further include means for transmitting, to the network entity, a configuration for AI/ML-based positioning based on the list of UE-supported features or feature groups related to the first set of AI/ML positioning functionalities or the AI/ML models.

In another configuration, the apparatus 1804 may further include means for receiving, from the network entity, one or more indications of AI/ML models associated with the set of network-supported features or feature groups related to the second set of AI/ML positioning functionalities. In some implementations, the apparatus 1804 may further include means for receiving, from the network entity, a configuration for AI/ML-based positioning based on the set of network-supported features or feature groups related to the second set of AI/ML positioning functionalities or the AI/ML models.

In another configuration, the apparatus 1804 may further include means for performing at least one of (1) a measurement of a set of positioning reference signals (PRSs) from at least one network node, or (2) an estimation of a location of the UE using one or more AI/ML models. In some implementations, the at least one network node may be a base station and the network entity is a location server or an LMF.

The means may be the positioning functionality exchange component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

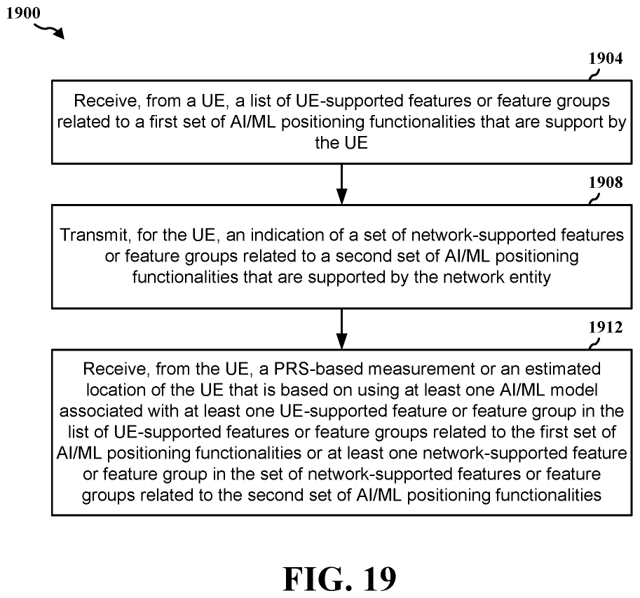

FIG. 19 is a flowchart 1900 of a method of wireless communication. The method may be performed by a network entity (e.g., the one or more location servers 168; the location server 504; the LMF 904, 1004; the network entity 2160). The method may enable the network entity to exchange AI/ML model functionalities and identifications with a UE such that the network entity and the UE may have a common understanding for AI/ML models used in association with AI/ML positioning, thereby improving the performance and efficiency of AI/ML positioning.

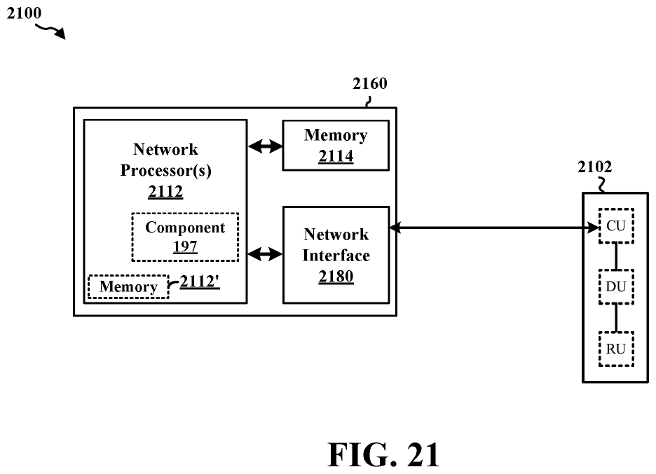

At 1904, the network entity may receive, from a UE, a list of UE-supported features or feature groups related to a first set of AI/ML positioning functionalities that are support by the UE, such as described in connection with FIG. 10. For example, at 1012, the LMF may receive, from the UE 1002, a list of supported AI/ML positioning functionality IDs (which may also be referred to or described as a list of supported features or feature groups associated with AI/ML positioning functionalities or functionality IDs). The reception of the list may be performed by, e.g., the positioning functionality exchange component 197, the network processor(s) 2112, and/or the network interface 2180 of the network entity 2160 in FIG. 21.

In one example, the network entity may transmit, for the UE, a request to provide the list of UE-supported features or feature groups related to the first set of AI/ML positioning functionalities, where the list of UE-supported features or feature groups related to the first set of AI/ML positioning functionalities is received based on the request.

At 1908, the network entity may transmit, for the UE, an indication of a set of network-supported features or feature groups related to a second set of AI/ML positioning functionalities that are supported by the network entity, such as described in connection with FIG. 10. For example, at 1016, the LMF 1004 may transmit, to or for the UE 1002, a set of AI/ML positioning functionalities (or a set of features or feature groups related to AI/ML positioning functionalities) supported by the LMF 1004. The transmission of the indication may be performed by, e.g., the positioning functionality exchange component 197, the network processor(s) 2112, and/or the network interface 2180 of the network entity 2160 in FIG. 21.

In one example, the network entity may transmit, for the UE, a request to provide the list of UE-supported features or feature groups related to the first set of AI/ML positioning functionalities, where the list of UE-supported features or feature groups related to the first set of AI/ML positioning functionalities is received based on the request, such as described in connection with FIG. 10. For example, at 1010, the LMF 1004 may transmit, to the UE 1002, a request requesting/asking the UE 1002 to indicate a list of AI/ML positioning functionality IDs (or a list of features or feature groups related to a set of AI/ML positioning functionality IDs) supported by the UE 1002. The transmission of the request may be performed by, e.g., the positioning functionality exchange component 197, the network processor(s) 2112, and/or the network interface 2180 of the network entity 2160 in FIG. 21.

In another example, the network entity may receive, from the UE, a list of indications on whether the UE supports one or more functionalities associated with an AI/ML model.

In another example, the network entity may transmit, for the UE, a query of whether the UE is capable of executing one or more functionalities associated with an AI/ML model provided by the network entity or a network node.

In another example, the network entity may transmit, for the UE, an inquiry of whether the UE is capable of performing the PRS-based measurement using one or more network-supported features or feature groups related to AI/ML positioning functionalities.

In another example, the network entity may receive, from the UE, one or more indications of AI/ML models associated with the list of UE-supported features or feature groups related to the first set of AI/ML positioning functionalities, such as described in connection with FIG. 10. For example, as shown at 1014, the LMF 1004 may also (and optionally) receive, from the UE 1002, a list of model IDs for a given model functionality. In some implementations, the LMF 1004 may also (and optionally) receive the AI/ML model(s) (or configurations for the AI/ML models) associated with the list of model ID(s) from the UE 1002. The reception of the one or more indications may be performed by, e.g., the positioning functionality exchange component 197, the network processor(s) 2112, and/or the network interface 2180 of the network entity 2160 in FIG. 21. In some implementations, the network entity may receive, from the UE, a configuration for AI/ML-based positioning based on the list of UE-supported features or feature groups related to the first set of AI/ML positioning functionalities or the AI/ML models.

In another example, the network entity may transmit, for the UE, one or more indications of AI/ML models associated with the set of network-supported features or feature groups related to the second set of AI/ML positioning functionalities, such as described in connection with FIG. 10. For example, at 1016, if an AI/ML model is implemented/configured at the UE 1002 (e.g., UE-sided AI/ML model), the AI/ML model may be provided by the LMF 1004 to the UE 1002. Thus, the LMF 1004 may transmit, to the UE 1002, a list of model IDs for a given model functionality and also the corresponding AI/ML model(s) as applicable. The transmission of the one or more indications may be performed by, e.g., the positioning functionality exchange component 197, the network processor(s) 2112, and/or the network interface 2180 of the network entity 2160 in FIG. 21.

In another example, each UE-supported feature or feature group in the list of UE-supported features or feature groups related to the first set of AI/ML positioning functionalities may be associated with a functionality ID.

In another example, each UE-supported feature or feature group in the list of UE-supported features or feature groups related to the first set of AI/ML positioning functionalities may be further associated with at least one of a model ID, a realization ID, or a structure ID.

In another example, each network-supported feature or feature group in the set of network-supported features or feature groups related to the second set of AI/ML positioning functionalities may be associated with a functionality ID. In some implementations, each network-supported feature or feature group in the set of network-supported features or feature groups related to the second set of AI/ML positioning functionalities may be further associated with at least one of a model ID, a realization ID, or a structure ID.

In another example, the network entity may transmit, for the UE, a configuration for AI/ML-based positioning based on the set of network-supported features or feature groups related to the second set of AI/ML positioning functionalities or the AI/ML models.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with direct AI/ML positioning or AI/ML assisted positioning.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning may be executed at the UE, at the network entity, or at a network node.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with at least one of an AI/ML model input or an AI/ML model output.

In another example, the network entity is a location server or an LMF.

At 1912, the network entity may receive, from the UE, a PRS-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities, such as described in connection with FIG. 10. For example, at 1020, the LMF 1004 may receive, from the UE 1002, PRS-based measurement(s) if the LMF 1004 is configured to determine the location of the UE 1002 (e.g., UE-assisted positioning), or the LMF 1004 may receive, from the UE 1002, an estimated location of the UE 1002 (determined by the UE 1002 for UE-based positioning), such as described in connection with FIG. 4. The reception of the set of RSs and/or the estimated location of the UE 1002 may be performed using at least one AI/ML model (e.g., based on AI/ML) positioning, where the at least one AI/ML model may be associated with the functionality ID(s), model ID(s), and/or realization/structure ID(S) supported by the UE 1002 and/or the LMF 1004. The reception of the PRS-based measurement and/or the estimated location of the UE may be performed by, e.g., the positioning functionality exchange component 197, the network processor(s) 2112, and/or the network interface 2180 of the network entity 2160 in FIG. 21.

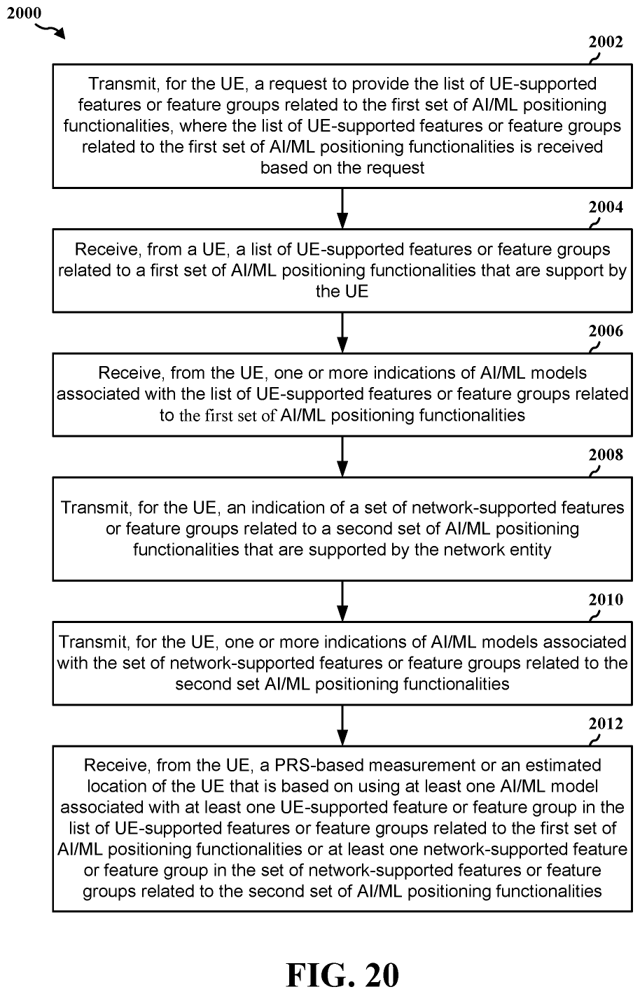

FIG. 20 is a flowchart 2000 of a method of wireless communication. The method may be performed by a network entity (e.g., the one or more location servers 168; the location server 504; the LMF 904, 1004; the network entity 2160). The method may enable the network entity to exchange AI/ML model functionalities and identifications with a UE such that the network entity and the UE may have a common understanding for AI/ML models used in association with AI/ML positioning, thereby improving the performance and efficiency of AI/ML positioning.

At 2002, the network entity may transmit, for the UE, a request to provide the list of UE-supported features or feature groups related to the first set of AI/ML positioning functionalities, where the list of UE-supported features or feature groups related to the first set of AI/ML positioning functionalities is received based on the request, such as described in connection with FIG. 10. For example, at 1010, the LMF 1004 may transmit, to the UE 1002, a request requesting/asking the UE 1002 to indicate a list of AI/ML positioning functionality IDs (or a list of features or feature groups related to a set of AI/ML positioning functionality IDs) supported by the UE 1002. The transmission of the request may be performed by, e.g., the positioning functionality exchange component 197, the network processor(s) 2112, and/or the network interface 2180 of the network entity 2160 in FIG. 21.

In one example, the network entity may receive, from the UE, a list of indications on whether the UE supports one or more functionalities associated with an AI/ML model.

In another example, the network entity may transmit, for the UE, a query of whether the UE is capable of executing one or more functionalities associated with an AI/ML model provided by the network entity or a network node.

In another example, the network entity may transmit, for the UE, an inquiry of whether the UE is capable of performing the PRS-based measurement using one or more network-supported features or feature groups related to AI/ML positioning functionalities.

At 2004, the network entity may receive, from a UE, a list of UE-supported features or feature groups related to a first set of AI/ML positioning functionalities that are support by the UE, such as described in connection with FIG. 10. For example, at 1012, the LMF may receive, from the UE 1002, a list of supported AI/ML positioning functionality IDs (which may also be referred to or described as a list of supported features or feature groups associated with AI/ML positioning functionalities or functionality IDs). The reception of the list may be performed by, e.g., the positioning functionality exchange component 197, the network processor(s) 2112, and/or the network interface 2180 of the network entity 2160 in FIG. 21.

In one example, the network entity may transmit, for the UE, a request to provide the list of UE-supported features or feature groups related to the first set of AI/ML positioning functionalities, where the list of UE-supported features or feature groups related to the first set of AI/ML positioning functionalities is received based on the request.

At 2006, the network entity may receive, from the UE, one or more indications of AI/ML models associated with the list of UE-supported features or feature groups related to the first set of AI/ML positioning functionalities, such as described in connection with FIG. 10. For example, as shown at 1014, the LMF 1004 may also (and optionally) receive, from the UE 1002, a list of model IDs for a given model functionality. In some implementations, the LMF 1004 may also (and optionally) receive the AI/ML model(s) (or configurations for the AI/ML models) associated with the list of model ID(s) from the UE 1002. The reception of the one or more indications may be performed by, e.g., the positioning functionality exchange component 197, the network processor(s) 2112, and/or the network interface 2180 of the network entity 2160 in FIG. 21. In some implementations, the network entity may receive, from the UE, a configuration for AI/ML-based positioning based on the list of UE-supported features or feature groups related to the first set of AI/ML positioning functionalities or the AI/ML models.

At 2008, the network entity may transmit, for the UE, an indication of a set of network-supported features or feature groups related to a second set of AI/ML positioning functionalities that are supported by the network entity, such as described in connection with FIG. 10. For example, at 1016, the LMF 1004 may transmit, to or for the UE 1002, a set of AI/ML positioning functionalities (or a set of features or feature groups related to AI/ML positioning functionalities) supported by the LMF 1004. The transmission of the indication may be performed by, e.g., the positioning functionality exchange component 197, the network processor(s) 2112, and/or the network interface 2180 of the network entity 2160 in FIG. 21.

At 2010, the network entity may transmit, for the UE, one or more indications of AI/ML models associated with the set of network-supported features or feature groups related to the second set of AI/ML positioning functionalities, such as described in connection with FIG. 10. For example, at 1016, if an AI/ML model is implemented/configured at the UE 1002 (e.g., UE-sided AI/ML model), the AI/ML model may be provided by the LMF 1004 to the UE 1002. Thus, the LMF 1004 may transmit, to the UE 1002, a list of model IDs for a given model functionality and also the corresponding AI/ML model(s) as applicable. The transmission of the one or more indications may be performed by, e.g., the positioning functionality exchange component 197, the network processor(s) 2112, and/or the network interface 2180 of the network entity 2160 in FIG. 21.

In one example, each UE-supported feature or feature group in the list of UE-supported features or feature groups related to the first set of AI/ML positioning functionalities may be associated with a functionality ID.

In another example, each UE-supported feature or feature group in the list of UE-supported features or feature groups related to the first set of AI/ML positioning functionalities may be further associated with at least one of a model ID, a realization ID, or a structure ID.

In another example, each network-supported feature or feature group in the set of network-supported features or feature groups related to the second set of AI/ML positioning functionalities may be associated with a functionality ID. In some implementations, each network-supported feature or feature group in the set of network-supported features or feature groups related to the second set of AI/ML positioning functionalities may be further associated with at least one of a model ID, a realization ID, or a structure ID.

In another example, the network entity may transmit, for the UE, a configuration for AI/ML-based positioning based on the set of network-supported features or feature groups related to the second set of AI/ML positioning functionalities or the AI/ML models.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with direct AI/ML positioning or AI/ML assisted positioning.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning may be executed at the UE, at the network entity, or at a network node.

In another example, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with at least one of an AI/ML model input or an AI/ML model output.

In another example, the network entity is a location server or an LMF.

At 2012, the network entity may receive, from the UE, a PRS-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities, such as described in connection with FIG. 10. For example, at 1020, the LMF 1004 may receive, from the UE 1002, PRS-based measurement(s) if the LMF 1004 is configured to determine the location of the UE 1002 (e.g., UE-assisted positioning), or the LMF 1004 may receive, from the UE 1002, an estimated location of the UE 1002 (determined by the UE 1002 for UE-based positioning), such as described in connection with FIG. 4. The reception of the set of RSs and/or the estimated location of the UE 1002 may be performed using at least one AI/ML model (e.g., based on AI/ML) positioning, where the at least one AI/ML model may be associated with the functionality ID(s), model ID(s), and/or realization/structure ID(S) supported by the UE 1002 and/or the LMF 1004. The reception of the PRS-based measurement and/or the estimated location of the UE may be performed by, e.g., the positioning functionality exchange component 197, the network processor(s) 2112, and/or the network interface 2180 of the network entity 2160 in FIG. 21.

FIG. 21 is a diagram 2100 illustrating an example of a hardware implementation for a network entity 2160. In one example, the network entity 2160 may be within the core network 120. The network entity 2160 may include at least one network processor 2112. The network processor(s) 2112 may include on-chip memory 2112′. In some aspects, the network entity 2160 may further include additional memory modules 2114. The network entity 2160 communicates via the network interface 2180 directly (e.g., backhaul link) or indirectly (e.g., through a RIC) with the CU 2102. The on-chip memory 2112′ and the additional memory modules 2114 may each be considered a computer-readable medium/memory. Each computer-readable medium/memory may be non-transitory. The network processor(s) 2112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the positioning functionality exchange component 197 may be configured to receive, from a UE, a list of UE-supported features or feature groups related to a first set of AI/ML positioning functionalities that are support by the UE. The positioning functionality exchange component 197 may also be configured to transmit, for the UE, an indication of a set of network-supported features or feature groups related to a second set of AI/ML positioning functionalities that are supported by the network entity. The positioning functionality exchange component 197 may also be configured to receive, from the UE, a PRS-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities. The component positioning functionality exchange component 197 may be within the network processor(s) 2112. The component positioning functionality exchange component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2160 may include a variety of components configured for various functions. In one configuration, the network entity 2160 may include means for receiving, from a UE, a list of UE-supported features or feature groups related to a first set of AI/ML positioning functionalities that are support by the UE. The network entity 2160 may further include means for transmitting, for the UE, an indication of a set of network-supported features or feature groups related to a second set of AI/ML positioning functionalities that are supported by the network entity. The network entity 2160 may further include means for receiving, from the UE, a PRS-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

In one configuration, the network entity 2160 may further include means for transmitting, for the UE, a request to provide the list of UE-supported features or feature groups related to the first set of AI/ML positioning functionalities, where the list of UE-supported features or feature groups related to the first set of AI/ML positioning functionalities is received based on the request.

In another configuration, the network entity 2160 may further include means for transmitting, for the UE, a request to provide the list of UE-supported features or feature groups related to the first set of AI/ML positioning functionalities, where the list of UE-supported features or feature groups related to the first set of AI/ML positioning functionalities is received based on the request.

In another configuration, the network entity 2160 may further include means for receiving, from the UE, a list of indications on whether the UE supports one or more functionalities associated with an AI/ML model.

In another configuration, the network entity 2160 may further include means for transmitting, for the UE, a query of whether the UE is capable of executing one or more functionalities associated with an AI/ML model provided by the network entity or a network node.

In another configuration, the network entity 2160 may further include means for transmitting, for the UE, an inquiry of whether the UE is capable of performing the PRS-based measurement using one or more network-supported features or feature groups related to AI/ML positioning functionalities.

In another configuration, the network entity 2160 may further include means for receiving, from the UE, one or more indications of AI/ML models associated with the list of UE-supported features or feature groups related to the first set of AI/ML positioning functionalities. In some implementations, the network entity 2160 may further include means for receiving, from the UE, a configuration for AI/ML-based positioning based on the list of UE-supported features or feature groups related to the first set of AI/ML positioning functionalities or the AI/ML models.

In another configuration, the network entity 2160 may further include means for transmitting, for the UE, one or more indications of AI/ML models associated with the set of network-supported features or feature groups related to the second set of AI/ML positioning functionalities.

In another configuration, each UE-supported feature or feature group in the list of UE-supported features or feature groups related to the first set of AI/ML positioning functionalities may be associated with a functionality ID.

In another configuration, each UE-supported feature or feature group in the list of UE-supported features or feature groups related to the first set of AI/ML positioning functionalities may be further associated with at least one of a model ID, a realization ID, or a structure ID.

In another configuration, each network-supported feature or feature group in the set of network-supported features or feature groups related to the second set of AI/ML positioning functionalities may be associated with a functionality ID. In some implementations, each network-supported feature or feature group in the set of network-supported features or feature groups related to the second set of AI/ML positioning functionalities may be further associated with at least one of a model ID, a realization ID, or a structure ID.

In another configuration, the network entity 2160 may further include means for transmitting, for the UE, a configuration for AI/ML-based positioning based on the set of network-supported features or feature groups related to the second set of AI/ML positioning functionalities or the AI/ML models.

In another configuration, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with direct AI/ML positioning or AI/ML assisted positioning.

In another configuration, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning may be executed at the UE, at the network entity, or at a network node.

In another configuration, each UE-supported feature or feature group in the list of UE-supported features or feature groups related to the first set of AI/ML positioning functionalities or each network-supported feature or feature group in the set of network-supported features or feature groups related to the second set of AI/ML positioning functionalities may be associated with at least one of an AI/ML model input or an AI/ML model output.

In another configuration, the network entity is a location server or an LMF.

The means may be the positioning functionality exchange component 197 of the network entity 2160 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network entity, comprising: receiving, from a user equipment (UE), a list of UE-supported features or feature groups related to a first set of artificial intelligence (AI)/machine learning (ML) (AI/ML) positioning functionalities that are support by the UE; transmitting, for the UE, an indication of a set of network-supported features or feature groups related to a second set of AI/ML positioning functionalities that are supported by the network entity; receiving, from the UE, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

Aspect 2 is the method of aspect 1, wherein each UE-supported feature or feature group in the list of UE-supported features or feature groups related to the first set of AI/ML positioning functionalities is associated with a functionality identification (ID).

Aspect 3 is the method of aspect 1 or aspect 2, wherein each UE-supported feature or feature group in the list of UE-supported features or feature groups related to the first set of AI/ML positioning functionalities is further associated with at least one of a model ID, a realization ID, or a structure ID.

Aspect 4 is the method of any of aspects 1 to 3, wherein each network-supported feature or feature group in the set of network-supported features or feature groups related to the second set of AI/ML positioning functionalities is associated with a functionality identification (ID).

Aspect 5 is the method of any of aspects 1 to 4, wherein each network-supported feature or feature group in the set of network-supported features or feature groups related to the second set of AI/ML positioning functionalities is further associated with at least one of a model ID, a realization ID, or a structure ID.

Aspect 6 is the method of any of aspects 1 to 5, further comprising: receiving, from the UE, one or more indications of AI/ML models associated with the list of UE-supported features or feature groups related to the first set of AI/ML positioning functionalities.

Aspect 7 is the method of any of aspects 1 to 6, further comprising: receiving, from the UE, a configuration for AI/ML-based positioning based on the list of UE-supported features or feature groups related to the first set of AI/ML positioning functionalities or the AI/ML models.

Aspect 8 is the method of any of aspects 1 to 7, further comprising: transmitting, for the UE, one or more indications of AI/ML models associated with the set of network-supported features or feature groups related to the second set of AI/ML positioning functionalities.

Aspect 9 is the method of any of aspects 1 to 8, further comprising: transmitting, for the UE, a configuration for AI/ML-based positioning based on the set of network-supported features or feature groups related to the second set of AI/ML positioning functionalities or the AI/ML models.

Aspect 10 is the method of any of aspects 1 to 9, further comprising: transmitting, for the UE, a request to provide the list of UE-supported features or feature groups related to the first set of AI/ML positioning functionalities, wherein the list of UE-supported features or feature groups related to the first set of AI/ML positioning functionalities is received based on the request.

Aspect 11 is the method of any of aspects 1 to 10, further comprising: receiving, from the UE, a list of indications on whether the UE supports one or more functionalities associated with an AI/ML model.

Aspect 12 is the method of any of aspects 1 to 11, further comprising: transmitting, for the UE, a query of whether the UE is capable of executing one or more functionalities associated with an AI/ML model provided by the network entity or a network node.

Aspect 13 is the method of any of aspects 1 to 12, further comprising: transmitting, for the UE, an inquiry of whether the UE is capable of performing the PRS-based measurement using one or more network-supported features or feature groups related to AI/ML positioning functionalities.

Aspect 14 is the method of any of aspects 1 to 13, wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities is associated with direct AI/ML positioning or AI/ML assisted positioning.

Aspect 15 is the method of any of aspects 1 to 14, wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning is to be executed at the UE, at the network entity, or at a network node.

Aspect 16 is the method of any of aspects 1 to 15, wherein each UE-supported feature or feature group in the list of UE-supported features or feature groups related to the first set of AI/ML positioning functionalities or each network-supported feature or feature group in the set of network-supported features or feature groups related to the second set of AJ/ML positioning functionalities is associated with at least one of an AI/ML model input or an AJ/ML model output.

Aspect 17 is the method of any of aspects 1 to 16, wherein the network entity is a location server or a location management function (LMF).

Aspect 18 is an apparatus for wireless communication at a network entity, including: at least one memory; and at least one processor coupled to the at least one memory and, based at least in part on information stored in the at least one memory, the at least one processor, individually or in any combination, is configured to implement any of aspects 1 to 17.

Aspect 19 is the apparatus of aspect 18, further including at least one of a transceiver or an antenna coupled to the at least one processor.

Aspect 20 is an apparatus for wireless communication including means for implementing any of aspects 1 to 17.

Aspect 21 is a computer-readable medium (e.g., a non-transitory computer-readable medium) storing computer executable code, where the code when executed by a processor causes the processor to implement any of aspects 1 to 17.

Aspect 22 is a method of wireless communication at a user equipment (UE), comprising: transmitting, to a network entity, a list of UE-supported features or feature groups related to a first set of artificial intelligence (AI)/machine learning (ML) (AI/ML) positioning functionalities that are support by the UE; receiving, from the network entity, an indication of a set of network-supported features or feature groups related to a second set of AI/ML positioning functionalities that are supported by the network entity; and transmitting, to the network entity, a positioning reference signal (PRS)-based measurement or an estimated location of the UE that is based on using at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

Aspect 23 is the method of aspect 22, wherein each UE-supported feature or feature group in the list of UE-supported features or feature groups related to the first set of AI/ML positioning functionalities is associated with a functionality identification (ID).

Aspect 24 is the method of aspect 22 or aspect 23, wherein each UE-supported feature or feature group in the list of UE-supported features or feature groups related to the first set of AI/ML positioning functionalities is further associated with at least one of a model ID, a realization ID, or a structure ID.

Aspect 25 is the method of any of aspects 22 to 24, wherein each network-supported feature or feature group in the set of network-supported features or feature groups related to the second set of AI/ML positioning functionalities is associated with a functionality identification (ID).

Aspect 26 is the method of any of aspects 22 to 25, wherein each network-supported feature or feature group in the set of network-supported features or feature groups related to the second set of AI/ML positioning functionalities is further associated with at least one of a model ID, a realization ID, or a structure ID.

Aspect 27 is the method of any of aspects 22 to 26, further comprising: transmitting, to the network entity, one or more indications of AI/ML models associated with the list of UE-supported features or feature groups related to the first set of AI/ML positioning functionalities.

Aspect 28 is the method of any of aspects 22 to 27, further comprising: transmitting, to the network entity, a configuration for AI/ML-based positioning based on the list of UE-supported features or feature groups related to the first set of AI/ML positioning functionalities or the AI/ML models.

Aspect 29 is the method of any of aspects 22 to 28, further comprising: receiving, from the network entity, one or more indications of AI/ML models associated with the set of network-supported features or feature groups related to the second set of AI/ML positioning functionalities.

Aspect 30 is the method of any of aspects 22 to 29, further comprising: receiving, from the network entity, a configuration for AI/ML-based positioning based on the set of network-supported features or feature groups related to the second set of AI/ML positioning functionalities or the AI/ML models.

Aspect 31 is the method of any of aspects 22 to 30, further comprising: receiving, from the network entity, a request to provide the list of UE-supported features or feature groups related to the first set of AI/ML positioning functionalities, wherein the list of UE-supported features or feature groups related to the first set of AI/ML positioning functionalities is transmitted based on the request.

Aspect 32 is the method of any of aspects 22 to 31, further comprising: transmitting, to the network entity, a list of indications indicating whether the UE supports one or more functionalities associated with an AI/ML model.

Aspect 33 is the method of any of aspects 22 to 32, further comprising: receiving, from the network entity, a query of whether the UE is capable of executing one or more functionalities associated with an AI/ML model provided by the network entity or a network node.

Aspect 34 is the method of any of aspects 22 to 33, further comprising: receiving, from the network entity, an inquiry of whether the UE is capable of performing the PRS-based measurement using one or more network-supported features or feature groups related to AI/ML positioning functionalities.

Aspect 35 is the method of any of aspects 22 to 34, wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities is associated with direct AI/ML positioning or AI/ML assisted positioning.

Aspect 36 is the method of any of aspects 22 to 35, wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning is to be executed at the UE, at the network entity, or at a network node.

Aspect 37 is the method of any of aspects 22 to 36, wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities is associated with at least one of an AI/ML model input or an AI/ML model output.

Aspect 38 is the method of any of aspects 22 to 37, further comprising: performing at least one of (1) a measurement of a set of positioning reference signals (PRSs) from at least one network node, or (2) an estimation of a location of the UE using one or more AI/ML models.

Aspect 39 is the method of any of aspects 22 to 38, wherein the at least one network node is a base station and the network entity is a location server or a location management function (LMF).

Aspect 40 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 22 to 39.

Aspect 41 is the apparatus of aspect 31, further including at least one of a transceiver or an antenna coupled to the at least one processor.

Aspect 42 is an apparatus for wireless communication including means for implementing any of aspects 22 to 39.

Aspect 43 is a computer-readable medium (e.g., a non-transitory computer-readable medium) storing computer executable code, where the code when executed by a processor causes the processor to implement any of aspects 22 to 39.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
transmit, to a network entity, a list of UE-supported features or feature groups related to a first set of artificial intelligence (AI)/machine learning (ML) (AI/ML) positioning functionalities that are support by the UE;
receive, from the network entity, an indication of a set of network-supported features or feature groups related to a second set of AI/ML positioning functionalities that are supported by the network entity; and
transmit, to the network entity, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group related in the set of network-supported features or feature groups related to the second set of AI/ML positioning functionalities.

2. The apparatus of claim 1, wherein each UE-supported feature or feature group in the list of UE-supported features or feature groups related to the first set of AI/ML positioning functionalities is associated with a functionality identification (ID).

3. The apparatus of claim 2, wherein each UE-supported feature or feature group in the list of UE-supported features or feature groups related to the first set of AI/ML positioning functionalities is further associated with at least one of a model ID, a realization ID, or a structure ID.

4. The apparatus of claim 1, wherein each network-supported feature or feature group in the set of network-supported features or feature groups related to the second set of AI/ML positioning functionalities is associated with a functionality identification (ID).

5. The apparatus of claim 4, wherein each network-supported feature or feature group in the set of network-supported features or feature groups related to the second set of AI/ML positioning functionalities is further associated with at least one of a model ID, a realization ID, or a structure ID.

6. The apparatus of claim 1, wherein the at least one processor, individually or in any combination, is further configured to:
transmit, to the network entity, one or more indications of AJ/ML models associated with the list of UE-supported features or feature groups related to the first set of AI/ML positioning functionalities.

7. The apparatus of claim 6, wherein the at least one processor, individually or in any combination, is further configured to:
transmit, to the network entity, a configuration for AI/ML-based positioning based on the list of UE-supported features or feature groups related to the first set of AI/ML positioning functionalities or the AI/ML models.

8. The apparatus of claim 1, wherein the at least one processor, individually or in any combination, is further configured to:
receive, from the network entity, one or more indications of AI/ML models associated with the set of network-supported features or feature groups related to the second set of AI/ML positioning functionalities.

9. The apparatus of claim 8, wherein the at least one processor, individually or in any combination, is further configured to:
receive, from the network entity, a configuration for AI/ML-based positioning based on the set of network-supported features or feature groups related to the second set of AI/ML positioning functionalities or the AI/ML models.

10. The apparatus of claim 1, wherein the at least one processor, individually or in any combination, is further configured to:
receive, from the network entity, a request to provide the list of UE-supported features or feature groups related to the first set of AI/ML positioning functionalities, wherein the list of UE-supported features or feature groups related to the first set of AI/ML positioning functionalities is transmitted based on the request.

11. The apparatus of claim 1, wherein the at least one processor, individually or in any combination, is further configured to:
transmit, to the network entity, a list of indications indicating whether the UE supports one or more functionalities associated with an AI/ML model.

12. The apparatus of claim 1, wherein the at least one processor, individually or in any combination, is further configured to:
receive, from the network entity, a query of whether the UE is capable of executing one or more functionalities associated with an AI/ML model provided by the network entity or a network node.

13. The apparatus of claim 1, wherein the at least one processor, individually or in any combination, is further configured to:
receive, from the network entity, an inquiry of whether the UE is capable of performing the PRS-based measurement using one or more network-supported features or feature groups related to AI/ML positioning functionalities.

14. The apparatus of claim 1, wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities is associated with direct AI/ML positioning or AI/ML assisted positioning.

15. The apparatus of claim 1, wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities indicates whether an AI/ML model associated with positioning is to be executed at the UE, at the network entity, or at a network node.

16. The apparatus of claim 1, further comprising at least one of a transceiver or an antenna coupled to the at least one processor, wherein to transmit the list of UE-supported features or feature groups, the at least one processor, individually or in any combination, is configured to transmit, via at least one of the transceiver or the antenna, the list of UE-supported features or feature groups, and wherein each UE-supported feature or feature group in the list of UE-supported features or feature groups related to the first set of AI/ML positioning functionalities or each network-supported feature or feature group in the set of network-supported features or feature groups related to the second set of AI/ML positioning functionalities is associated with at least one of an AI/ML model input or an AI/ML model output.

17. The apparatus of claim 1, wherein the at least one processor, individually or in any combination, is further configured to:
perform at least one of (1) a measurement of a set of positioning reference signals (PRSs) from at least one network node, or (2) an estimation of a location of the UE using one or more AI/ML models.

18. A method of wireless communication at a user equipment (UE), comprising:
transmitting, to a network entity, a list of UE-supported features or feature groups related to a first set of artificial intelligence (AI)/machine learning (ML) (AI/ML) positioning functionalities that are support by the UE;
receiving, from the network entity, an indication of a set of network-supported features or feature groups related to a second set of AI/ML positioning functionalities that are supported by the network entity; and
transmitting, to the network entity, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

19. An apparatus for wireless communication at a network entity, comprising:
at least one memory; and
at least one processor coupled to the at least one memory and, based at least in part on information stored in the at least one memory, the at least one processor, individually or in any combination, is configured to:
receive, from a user equipment (UE), a list of UE-supported features or feature groups related to a first set of artificial intelligence (AI)/machine learning (ML) (AI/ML) positioning functionalities that are support by the UE;
transmit, for the UE, an indication of a set of network-supported features or feature groups related to a second set of AI/ML positioning functionalities that are supported by the network entity; and
receive, from the UE, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.

20. The apparatus of claim 19, wherein each UE-supported feature or feature group in the list of UE-supported features or feature groups related to the first set of AI/ML positioning functionalities is associated with a functionality identification (ID).

21. The apparatus of claim 20, wherein each UE-supported feature or feature group in the list of UE-supported features or feature groups related to the first set of AI/ML positioning functionalities is further associated with at least one of a model ID, a realization ID, or a structure ID.

22. The apparatus of claim 19, wherein each network-supported feature or feature group in the set of network-supported features or feature groups related to the second set of AI/ML positioning functionalities is associated with a functionality identification (ID).

23. The apparatus of claim 22, further comprising at least one of a transceiver or an antenna coupled to the at least one processor, wherein to receive the list of UE-supported features or feature groups, the at least one processor, individually or in any combination, is configured to receive, via at least one of the transceiver or the antenna, the list of UE-supported features or feature groups, and wherein each network-supported feature or feature group in the set of network-supported features or feature groups related to the second set of AI/ML positioning functionalities is further associated with at least one of a model ID, a realization ID, or a structure ID.

24. The apparatus of claim 19, wherein the at least one processor, individually or in any combination, is further configured to:
receive, from the UE, one or more indications of AI/ML models associated with the list of UE-supported features or feature groups related to the first set of AI/ML positioning functionalities; and
receive, from the UE, a configuration for AI/ML-based positioning based on the list of UE-supported features or feature groups related to the first set of AI/ML positioning functionalities or the AI/ML models.

25. The apparatus of claim 19, wherein the at least one processor, individually or in any combination, is further configured to:
transmit, for the UE, one or more indications of AI/ML models associated with the set of network-supported features or feature groups related to the second set of AI/ML positioning functionalities; and
transmit, for the UE, a configuration for AI/ML-based positioning based on the set of network-supported features or feature groups related to the second set of AI/ML positioning functionalities or the AI/ML models.

26. The apparatus of claim 19, wherein the at least one processor, individually or in any combination, is further configured to:
transmit, for the UE, a request to provide the list of UE-supported features or feature groups related to the first set of AI/ML positioning functionalities, wherein the list of UE-supported features or feature groups related to the first set of AI/ML positioning functionalities is received based on the request.

27. The apparatus of claim 19, wherein the at least one processor, individually or in any combination, is further configured to:
receive, from the UE, a list of indications on whether the UE supports one or more functionalities associated with an AI/ML model.

28. The apparatus of claim 19, wherein the at least one processor, individually or in any combination, is further configured to:
transmit, for the UE, a query of whether the UE is capable of executing one or more functionalities associated with an AI/ML model provided by the network entity or a network node.

29. The apparatus of claim 19, wherein the at least one processor, individually or in any combination, is further configured to:
transmit, for the UE, an inquiry of whether the UE is capable of performing the PRS-based measurement using one or more network-supported features or feature groups related to AI/ML positioning functionalities.

30. A method of wireless communication at a network entity, comprising:
receiving, from a user equipment (UE), a list of UE-supported features or feature groups related to a first set of artificial intelligence (AI)/machine learning (ML) (AI/ML) positioning functionalities that are support by the UE;
transmitting, for the UE, an indication of a set of network-supported features or feature groups related to a second set of AJ/ML positioning functionalities that are supported by the network entity; and
receiving, from the UE, a positioning reference signal (PRS)-based measurement or an estimated location of the UE that is based on using at least one AI/ML model associated with at least one UE-supported feature or feature group in the list of UE-supported features or feature groups related to the first set of AI/ML positioning functionalities or at least one network-supported feature or feature group in the set of network-supported features or feature groups related to the second set of AI/ML positioning functionalities.
